(19) United States
(12) Patent Application Publication
(10) Pub. No.: US 2026/0251573 A1
(43) Pub. Date: Aug. 27, 2026

(54) SEQUENCING SYSTEM WITH CURVED IMAGE PLANE OR OBJECT PLANE

(71) Applicant: ILLUMINA, INC., San Diego, CA (US)

(72) Inventors: Steve BOEGE, San Mateo, CA (US); Rean Silke MUSA, San Diego, CA (US); Michael BUREK, San Diego, CA (US); Alexa HUDNUT, San Diego, CA (US)

(21) Appl. No.: 18/877,290

(22) PCT Filed: Jun. 21, 2023
(86) PCT No.: PCT/US2023/025805

§ 371 Date: Dec. 20, 2024

Related U.S. Application Data
(60) Provisional application No. 63/357,072, filed on Jun. 30, 2022.

(51) Int. Cl. G01N 21/64

(52) U.S. Cl. CPC G01N 21/6486; G01N 21/6428; G01N 2021/6419; G01N 2021/6439

(57) ABSTRACT

An apparatus includes a flow cell and an image sensor. The flow cell includes a plurality of reaction sites. The flow cell is configured to receive a fluid and an excitation light. Each reaction site is configured to contain a biological sample carried by the fluid. The reaction sites together are positioned along a reaction site plane. The image sensor is positioned to receive light emitted from the reaction site in response to the excitation light. The image sensor defines an imaging surface. The imaging surface defines an imaging surface plane. One or both of the reaction site plane or the imaging surface plane is curved.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Aspects of the present disclosure relate generally to biological or chemical analysis and more particularly to systems and methods using image sensors for biological or chemical analysis.

Various protocols in biological or chemical research involve performing a large number of controlled reactions on local support surfaces or within predefined reaction chambers. The designated reactions may then be observed or detected, and subsequent analysis may help identify or reveal properties of chemicals involved in the reaction. For example, in some multiplex assays, an unknown analyte having an identifiable label (e.g., fluorescent label) may be exposed to thousands of known probes under controlled conditions. Each known probe may be deposited into a corresponding well of a flow cell channel. Observing any chemical reactions that occur between the known probes and the unknown analyte within the wells may help identify or reveal properties of the analyte. Other examples of such protocols include known DNA sequencing processes, such as sequencing-by-synthesis (SBS) or cyclic-array sequencing.

In some conventional fluorescent-detection protocols, an optical system is used to direct an excitation light onto fluorescently-labeled analytes and to also detect the fluorescent signals that may be emitted from the analytes. Such optical systems may include an arrangement of lenses, filters, and light sources. Some conventional sequencing systems may tend to capture images of flat objects (e.g., flat reaction site surfaces in a flow cell) using flat image sensors. To improve imaging performance in a sequencing system, it may be beneficial to provide a curvature in either the object plane (i.e., in the imaged object) or the image plane (i.e., in the imaging sensor).

### BRIEF DESCRIPTION OF THE DRAWINGS

FIG. 1 depicts a schematic diagram of an example of an imaging system that may be implemented in a system for biological or chemical analysis.

FIG. 2 depicts a schematic diagram of an example of an imaging arrangement, including an objective lens projecting an image of a substantially flat object onto a substantially flat image plane.

FIG. 3 depicts a spot diagram representing an image captured using the imaging arrangement of FIG. 2, for the region of the object at the center of the field of view (on axis, 0 mm off-axis).

FIG. 4 depicts another spot diagram representing an image captured using the imaging arrangement of FIG. 2, for a region of the object at the edge of the field of view (e.g., 1 mm off-axis).

FIG. 5 depicts a graph plotting surface depth of the image plane of FIG. 2 across the width of the image plane.

FIG. 6 depicts a graph plotting root mean square (RMS) wavefront error across a width of an image captured using the arrangement of FIG. 2.

FIG. 7 depicts a schematic diagram of another example of an imaging arrangement, including an objective lens projecting an image of a substantially flat object onto a curved image plane.

FIG. 8 depicts a spot diagram representing an image captured using the imaging arrangement of FIG. 7, for the region of the object at the center of the field of view (on axis, 0 mm off-axis).

FIG. 9 depicts another spot diagram representing an image captured using the imaging arrangement of FIG. 2, for a region of the object at the edge of the field of view (e.g., 1 mm off-axis).

FIG. 10 depicts a graph plotting surface depth of the image plane of FIG. 7 across the width of the image plane.

FIG. 11 depicts a graph plotting RMS wavefront error across a width of an image captured using the arrangement of FIG. 7.

FIG. 12 depicts a perspective view of an example of an image sensor with a cylindrical curvature.

FIG. 13 depicts a top plan view of the image sensor of FIG. 12.

FIG. 14 depicts a perspective view of an example of an image sensor with a spherical curvature.

FIG. 15 depicts a top plan view of the image sensor of FIG. 14.

FIG. 16A depicts a side schematic view of an example of an image sensor assembly, with a sensor bending actuator of the assembly deactivated, such that an image sensor of the assembly is substantially flat.

FIG. 16B depicts a side schematic view of the image sensor assembly of FIG. 16A, with the sensor bending actuator activated, such that the image sensor is bent to form a curve.

FIG. 17A depicts a side schematic view of another example of an image sensor assembly, with a sensor bending actuator of the assembly deactivated, such that an image sensor of the assembly is substantially flat.

FIG. 17B depicts a side schematic view of the image sensor assembly of FIG. 17A, with the sensor bending actuator activated, such that the image sensor is bent to form a curve.

FIG. 18A depicts a side schematic view of another example of an image sensor assembly, with a sensor bending actuator of the assembly deactivated, such that an image sensor of the assembly is substantially flat.

FIG. 18B depicts a side schematic view of the image sensor assembly of FIG. 18A, with the sensor bending actuator activated, such that the image sensor is bent to form a curve.

FIG. 19 depicts a side schematic view of an example of an image sensor assembly including bend sensors.

FIG. 20 depicts a schematic diagram of another example of an imaging arrangement, including an objective lens projecting an image of a curved object onto a substantially flat image plane.

FIG. 21 depicts a spot diagram representing an image captured using the imaging arrangement of FIG. 20, for the region of the object at the center of the field of view (on axis, 0 mm off-axis).

FIG. 22 depicts another spot diagram representing an image captured using the imaging arrangement of FIG. 20, for a region of the object at the edge of the field of view (e.g., 1 mm off-axis).

FIG. 23 depicts a graph plotting surface depth of the object plane of FIG. 20 across the width of the image plane.

FIG. 24 depicts a graph plotting RMS wavefront error across a width of an image captured using the arrangement of FIG. 20.

FIG. 25A depicts a side schematic view of an example of a flow cell having a deformable substrate, with the substrate in a substantially flat state.

FIG. 25B depicts a side schematic view of the flow cell of FIG. 25A, with the substrate bent to position reaction sites along a curved plane.

FIG. 26 depicts a side schematic view of another example of a flow cell, with reaction sites in tier groupings along a curved plane.

FIG. 27 depicts a side schematic view of another example of a flow cell, with an integral lens element.

### DETAILED DESCRIPTION

### I. Overview of System for Biological or Chemical Analysis

Described herein are devices, systems, and methods for providing a curvature in the object plane or the image plane in a sequencing system, to thereby improve imaging performance without unduly increasing the size or mass of lens elements within an optical assembly of the sequencing system. Examples described herein may be used in various biological or chemical processes and systems for academic analysis, commercial analysis, or other analysis. More specifically, examples described herein may be used in various processes and systems where it is desired to detect an event, property, quality, or characteristic that is indicative of a designated reaction.

Bioassay systems such as those described herein may be configured to perform a plurality of designated reactions that may be detected individually or collectively. The biosensors and bioassay systems may be configured to perform numerous cycles in which a plurality of designated reactions occurs in parallel. For example, the bioassay systems may be used to sequence a dense array of DNA features through iterative cycles of enzymatic manipulation and image acquisition. Cartridges and biosensors that are used in the bioassay systems may include one or more microfluidic channels that deliver reagents or other reaction components to a reaction site. The reaction sites may be randomly distributed across a substantially planar surface; or may be patterned across a substantially planar surface in a predetermined manner. In some versions, the reaction sites are located in reaction chambers that compartmentalize the designated reactions therein.

Regardless of the form taken by the reaction sites, each of the reaction sites may be imaged to detect light from the reaction site. In some examples, one or more image sensors may detect light emitted from reaction sites. The signals indicating photons emitted from the reaction sites and detected by the individual image sensors may be referred to as those sensors' illumination values. These illumination values may be combined into an image indicating photons as detected from the reaction sites. These images may be further analyzed to identify compositions, reactions, conditions, etc., at each reaction site.

The following detailed description of certain examples will be better understood when read in conjunction with the appended drawings. To the extent that the figures illustrate diagrams of the functional blocks of various examples, the functional blocks are not necessarily indicative of the division between hardware components. Thus, for example, one or more of the functional blocks (e.g., processors or memories) may be implemented in a single piece of hardware (e.g., a general purpose signal processor or random access memory, hard disk, or the like). Similarly, the programs may be stand-alone programs, may be incorporated as subroutines in an operating system, may be functions in an installed software package, and the like. It should be understood that the various examples are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one example” are not intended to be interpreted as excluding the existence of additional examples that also incorporate the recited features. Moreover, unless explicitly stated to the contrary, examples “comprising” or “having” an element or a plurality of elements having a particular property may include additional elements whether or not they have that property.

As used herein, a “designated reaction” includes a change in at least one of a chemical, electrical, physical, or optical property (or quality) of an analyte-of-interest. In some examples, the designated reaction is a positive binding event (e.g., incorporation of a fluorescently labeled biomolecule with the analyte-of-interest). More generally, the designated reaction may be a chemical transformation, chemical change, or chemical interaction. In some examples, the designated reaction includes the incorporation of a fluorescently-labeled molecule to an analyte. The analyte may be an oligonucleotide and the fluorescently-labeled molecule may be a nucleotide. The designated reaction may be detected when an excitation light is directed toward the oligonucleotide having the labeled nucleotide, and the fluorophore emits a detectable fluorescent signal. In alternative examples, the detected fluorescence is a result of chemiluminescence or bioluminescence. A designated reaction may also increase fluorescence (or Förster) resonance energy transfer (FRET), for example, by bringing a donor fluorophore in proximity to an acceptor fluorophore, decrease FRET by separating donor and acceptor fluorophores, increase fluorescence by separating a quencher from a fluorophore or decrease fluorescence by co-locating a quencher and fluorophore.

As used herein, a “reaction component” or “reactant” includes any substance that may be used to obtain a designated reaction. For example, reaction components include reagents, enzymes, samples, other biomolecules, and buffer solutions. The reaction components may be delivered to a reaction site in a solution and/or immobilized at a reaction site. The reaction components may interact directly or indirectly with another substance, such as the analyte-of-interest.

As used herein, the term “reaction site” is a localized region where a designated reaction may occur. A reaction site may include support surfaces of a substrate where a substance may be immobilized thereon. For example, a reaction site may include a substantially planar surface in a channel of a flow cell that has a colony of nucleic acids thereon. The nucleic acids in the colony may have the same sequence, being for example, clonal copies of a single stranded or double stranded template. However, in some examples a reaction site may contain only a single nucleic acid molecule, for example, in a single stranded or double stranded form. Furthermore, a plurality of reaction sites may be randomly distributed along the support surface or arranged in a predetermined manner (e.g., side-by-side in a matrix, such as in microarrays). A reaction site may also include a reaction chamber that at least partially defines a spatial region or volume configured to compartmentalize the designated reaction. As used herein, the term “reaction chamber” includes a spatial region that is in fluid communication with a flow channel. The reaction chamber may be at least partially separated from the surrounding environment or other spatial regions. For example, a plurality of reaction chambers may be separated from each other by shared walls. As a more specific example, the reaction chamber may include a cavity defined by interior surfaces of a well and have an opening or aperture so that the cavity may be in fluid communication with a flow channel. Reaction sites do not necessarily need to be provided in reaction chambers and may instead be provided on or in any other suitable kind of structure.

As used herein, the term “adjacent” when used with respect to two reaction sites means no other reaction site is located between the two reaction sites. The term “adjacent” may have a similar meaning when used with respect to adjacent detection paths and adjacent image sensors (e.g., adjacent image sensors have no other image sensor therebetween). In some cases, a reaction site may not be adjacent to another reaction site; but may still be within an immediate vicinity of the other reaction site. A first reaction site may be in the immediate vicinity of a second reaction site when fluorescent emission signals from the first reaction site are detected by the image sensor associated with the second reaction site. More specifically, a first reaction site may be in the immediate vicinity of a second reaction site when the image sensor associated with the second reaction site detects, for example, crosstalk from the first reaction site. Adjacent reaction sites may be contiguous such that they abut each other or the adjacent sites may be non-contiguous having an intervening space between.

As used herein, a “substance” includes items or solids, such as capture beads, as well as biological or chemical substances. As used herein, a “biological or chemical substance” includes biomolecules, samples-of-interest, analytes-of-interest, and other chemical compound(s). A biological or chemical substance may be used to detect, identify, or analyze other chemical compound(s), or function as intermediaries to study or analyze other chemical compound(s). In particular examples, the biological or chemical substances include a biomolecule. As used herein, a “biomolecule” includes at least one of a biopolymer, nucleoside, nucleic acid, polynucleotide, oligonucleotide, protein, enzyme, polypeptide, antibody, antigen, ligand, receptor, polysaccharide, carbohydrate, polyphosphate, cell, tissue, organism, or fragment thereof or any other biologically active chemical compound(s) such as analogs or mimetics of the aforementioned species.

Biomolecules, samples, and biological or chemical substances may be naturally occurring or synthetic and may be suspended in a solution or mixture within a spatial region. Biomolecules, samples, and biological or chemical substances may also be bound to a solid phase or gel material. Biomolecules, samples, and biological or chemical substances may also include a pharmaceutical composition. In some cases, biomolecules, samples, and biological or chemical substances of interest may be referred to as targets, probes, or analytes.

As used herein, when the terms “removably” and “coupled” (or “engaged”) are used together to describe a relationship between components, the term is intended to mean that a connection between the components is readily separable without destroying or damaging the components. Components are readily separable when the components may be separated from each other without undue effort, or without a significant amount of time spent, in separating the components. For example, components may be removably coupled or engaged in an electrical manner such that the mating contacts of the components are not destroyed or damaged. Components may also be removably coupled or engaged in a mechanical manner such that the features that hold a component are not destroyed or damaged. Components may also be removably coupled or engaged in a fluidic manner such that ports of a component are not destroyed or damaged. The component is not considered to be destroyed or damaged if, for example, only a simple adjustment to the component (e.g., realignment) or a simple replacement (e.g., replacing a nozzle) is required.

As used herein, the term “fluid communication” or “fluidically coupled” refers to two spatial regions being connected together such that a liquid or gas may flow between the two spatial regions. For example, a microfluidic channel may be in fluid communication with a reaction chamber such that a fluid may flow freely into the reaction chamber from the microfluidic channel. The terms “in fluid communication” or “fluidically coupled” allow for two spatial regions being in fluid communication through one or more valves, restrictors, or other fluidic components to control or regulate a flow of fluid through a system.

As used herein, the term “immobilized,” when used with respect to a biomolecule or biological or chemical substance, includes substantially attaching the biomolecule or biological or chemical substance at a molecular level to a surface. For example, a biomolecule or biological or chemical substance may be immobilized to a surface of the substrate material using adsorption techniques including non-covalent interactions (e.g., electrostatic forces, van der Waals, and dehydration of hydrophobic interfaces) and covalent binding techniques where functional groups or linkers facilitate attaching the biomolecules to the surface. Immobilizing biomolecules or biological or chemical substances to a surface of a substrate material may be based upon the properties of the substrate surface, the liquid medium carrying the biomolecule or biological or chemical substance, and the properties of the biomolecules or biological or chemical substances themselves. In some cases, a substrate surface may be functionalized (e.g., chemically or physically modified) to facilitate immobilizing the biomolecules (or biological or chemical substances) to the substrate surface. The substrate surface may be first modified to have functional groups bound to the surface. The functional groups may then bind to biomolecules or biological or chemical substances to immobilize them thereon.

As used herein, the term “magnet,” includes permanent magnets and electromagnets.

In some examples, nucleic acids can be attached to a surface and amplified. Examples of such amplification are described in U.S. Pat. No. 7,741,463, entitled “Method of Preparing Libraries of Template Polynucleotides,” issued Jun. 22, 2010, the disclosure of which is incorporated by reference herein, in its entirety. In some cases, repeated rounds of extension (e.g., amplification) using an immobilized primer and primer in solution may provide multiple copies of the nucleic acid.

In particular examples, the assay protocols executed by the systems and methods described herein include the use of natural nucleotides and also enzymes that are configured to interact with the natural nucleotides. Natural nucleotides include, for example, ribonucleotides or deoxyribonucleotides. Natural nucleotides can be in the mono-, di-, or tri-phosphate form and can have a base selected from adenine (A), Thymine (T), uracil (U), guanine (G) or cytosine (C). It will be understood however that non-natural nucleotides, modified nucleotides, or analogs of the aforementioned nucleotides can be used.

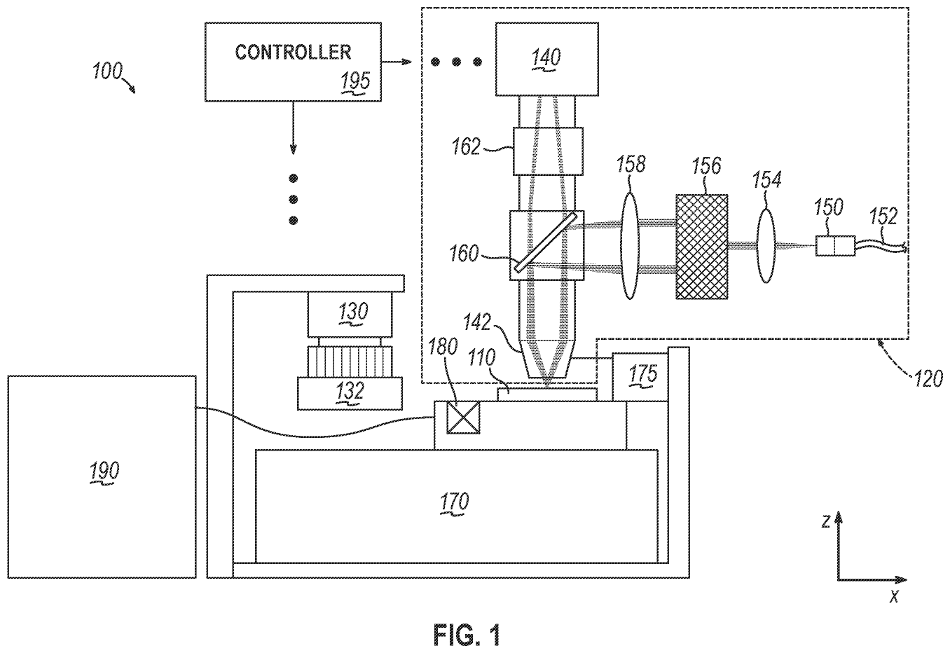

FIG. 1 depicts an example of components of a system (100) that may be used to provide biological or chemical analysis. In some examples, system (100) is a workstation that may be similar to a bench-top device. For example, a majority (or all) of the systems and components for conducting the designated reactions may be within a common housing. In particular examples, system (100) is a nucleic acid sequencing system (or sequencer) configured for various applications, including but not limited to de novo sequencing, resequencing of whole genomes or target genomic regions, and metagenomics. The sequencer may also be used for DNA or RNA analysis. In some versions, system (100) may also be configured to generate reaction sites in a flow cell (110). For example, system (100) may be configured to receive a sample and generate surface attached clusters of clonally amplified nucleic acids derived from the sample. In some implementations, the cluster may comprise a particular sample that is a distinguishable portion of the cluster even if the cluster is polyclonal as a result of one or more other samples being present within the cluster. System (100) is further configured to utilize an imaging assembly (120) to capture images of the reaction sites on flow cell (110).

In particular examples, the system (100) is to perform a large number of parallel reactions within flow cell (110). Flow cell (110) includes one or more reaction sites where designated reactions may occur. The reaction sites may be, for example, immobilized to a solid surface of flow cell (110) or immobilized to beads (or other movable substrates) that are located within corresponding reaction chambers of flow cell (110). The reaction sites may include, for example, clusters of clonally amplified nucleic acids. Flow cell (110) may include one or more flow channels that receive a solution from the system (100) and direct the solution toward the reaction sites. Optionally, flow cell (110) may engage a thermal element for transferring thermal energy into or out of the flow channel.

System (100) may include various components, assemblies, and systems (or sub-systems) that interact with each other to perform a predetermined method or assay protocol for biological or chemical analysis. For example, system (100) includes a system controller (195) that may communicate with the various components, assemblies, and sub-systems of the system (100). Examples of such components are described in greater detail below. Controller (195) may include one or more microprocessors, storage devices, and/or any other suitable electrical components that are configured to cooperate to execute control algorithms, data processing, etc.

In the present example, imaging assembly (120) includes a light emitter (150) that emits light that reaches reaction sites on flow cell (110). Light emitter (150) may include an incoherent light emitter (e.g., emit light beams output by one or more excitation diodes), or a coherent light emitter such as emitter of light output by one or more lasers or laser diodes. In the present example, light emitter (150) includes an optical fiber (152) for guiding an optical beam to be output via light emitter. However, other configurations of a light emitter (150) may be used. In some implementations, optical fiber (152) may optically couple to a plurality of different light sources (not shown), each light source emitting light of a different wavelength range. Although system (100) is illustrated as having a single light emitter (150), multiple light emitters (150) may be included in some other implementations.

In the present example, the light that is output from light emitter (150) is collimated by collimation lens (154). The collimated light is structured (patterned) by light structuring optical assembly (156) and reaches a projection lens (158). In some versions, projection lens (158) includes a lens element that is operable to translate along an axis (i.e., the axis on which light emitter (150), collimation lens (154), and light structuring optical assembly (156) are aligned) to adjust the structured beam shape and path. For example, projection lens (156) may be translated along this axis to account for a range of sample thicknesses (e.g., different cover glass thickness) of the sample in flow cell (110). In other implementations, projection lens (156) may be fixed and/or omitted and a moveable lens element may be positioned within a tube lens assembly in the emission optical path to account for focusing on an upper interior surface or lower interior surface of the flow cell (110) and/or spherical aberration introduced by movement of the objective lens assembly (142). The foregoing illumination components (150, 152, 154, 156, 158) are just examples. System (100) may alternatively include any other suitable components to provide illumination, in addition to or in lieu of any of the illumination components (150, 152, 154, 156, 158) described above. For instance, some other variations may omit structuring optical assembly (156) to use non-structured illumination and/or any other kind of illumination and/or optical arrangements (e.g., epifluorescence microscopy, etc.).

In the present example, the light directed by dichroic mirror (160) through objective lens assembly (142) onto a sample of a flow cell (110), which is positioned on a motion stage (170). In the case of a fluorescent microscopy of a sample, a fluorescent element associated with the sample of interest fluoresces in response to the excitation light, and the resultant light is collected by objective lens assembly (142) is directed to an image sensor of camera system (140) to detect the emitted fluorescence. As noted above, in some implementations, a tube lens assembly may be positioned between the objective lens assembly (142) and the dichroic mirror (160) or between the dichroic mirror (160) and the image sensor of the camera system (140). A moveable lens element may be translatable along a longitudinal axis of the tube lens assembly to account for focusing on an upper interior surface or lower interior surface of the flow cell (110) and/or spherical aberration introduced by movement of the objective lens assembly (142). In some implementations, a filter switching assembly (162) with one or more emission filters may be included, where the one or more emission filters may be used to pass through particular ranges of emission wavelengths and block (or reflect) other ranges of emission wavelengths. For example, the one or more emission filters may be used to direct different wavelength ranges of emitted light to different image sensors of the camera system (140) of imaging assembly (120). For instance, the emission filters may be implemented as dichroic mirrors that direct emission light of different wavelengths from flow cell (110) to different image sensors of camera system (140). In some variations, projection lens (158) is interposed between filter switching assembly (162) and camera system (140) instead of being positioned as shown in FIG. 1. Filter switching assembly (162) may be omitted in some versions.

In the example of system (100), fluid delivery module or device (190) may direct the flow of reagents (e.g., fluorescently labeled nucleotides, buffers, enzymes, cleavage reagents, etc.) to (and through) flow cell (110) and waste valve (180). Flow cell (110) may include one or more substrates upon which the samples are provided. For example, in the case of a system to analyze a large number of different nucleic acid sequences, flow cell (110) may include one or more substrates on which nucleic acids to be sequenced are bound, attached, or associated. The substrate may include any inert substrate or matrix to which nucleic acids may be attached, such as for example glass surfaces, plastic surfaces, latex, dextran, polystyrene surfaces, polypropylene surfaces, polyacrylamide gels, gold surfaces, and silicon wafers. In some applications, the substrate is within a channel or includes a channel formed within the substrate or other area at a plurality of locations formed in a matrix or array across the flow cell (110). System (100) may also include a temperature station actuator (130) and heater/cooler (132) that may optionally regulate the temperature of conditions of the fluids within the flow cell (110). In some implementations, the heater/cooler (132) may be fixed to a sample stage (170) upon which the flow cell (110) is placed and/or may be integrated therein to sample stage (170).

In particular implementations, the flow cell (110) may be implemented as a patterned flow cell including a transparent cover plate, a substrate, and configured to contain a liquid therebetween, and a biological sample may be located at an inside surface of the transparent cover plate and/or an inside surface of the substrate. The flow cell may include a large number (e.g., thousands, millions, or billions) of wells (also referred to as nanowells) or regions that are patterned into a defined array (e.g., a hexagonal array, rectangular array, etc.) into the substrate. Such wells may define reaction chambers providing reaction sites as described above. Each region may form a cluster (e.g., a monoclonal cluster, a substantially monoclonal cluster, or a polyclonal cluster) or more one than cluster of a biological sample such as DNA, RNA, or another genomic material that may be sequenced, for example, using sequencing by synthesis. A substantially monoclonal cluster may be one where a particular sample forms a distinguishable portion of the cluster even if the cluster itself is polyclonal as a result of one or more other samples being present within the cluster. The flow cell (110) may be further divided into a number of spaced apart lanes (e.g., eight lanes), each lane including a hexagonal array of clusters or a rectilinear array of clusters.

Flow cell (110) may be mounted on a sample stage (170) to provide movement and alignment of flow cell (110) relative to objective lens assembly (142). Sample stage (170) may have one or more actuators to allow sample stage (170) to move in any of three dimensions. For example, in terms of the Cartesian coordinate system, actuators may be provided to allow sample stage (170) to move in the x, y, and z directions relative to objective lens assembly (142), tilt relative to objective lens assembly (142), and/or otherwise move relative to objective lens assembly (142). Movement of sample stage (170) may allow one or more sample locations on flow cell (110) to be positioned in optical alignment with objective lens assembly (142). Movement of sample stage (170) relative to objective lens assembly (142) may be achieved by moving sample stage (170) itself, by moving objective lens assembly (142), by moving some other component of imaging assembly (120), by moving some other component of system (100), or any combination of the foregoing. For instance, in some implementations, the sample stage (170) may be actuatable in the X and Y directions relative to the objective lens assembly (142) while a focus component (175) or Z-stage may move the objective lens assembly (142) along the Z direction relative to the sample stage (170). Further implementations may also include moving imaging assembly (120) over a stationary flow cell (110). Thus, in some versions, flow cell (110) may be fixed during imaging while one or more components of imaging assembly (120) is/are moved to capture images at different regions of flow cell (110).

In some implementations, a focus component (175) may be included to control positioning of the objective lens assembly (142) relative to the flow cell (110) in the focus direction (e.g., along the z-axis or z-dimension). Focus component (175) may include one or more actuators physically coupled to objective lens assembly (142), the optical stage, sample stage (170), or a combination thereof, to move flow cell (110) on sample stage (170) relative to the objective lens assembly (142) to provide proper focusing for the imaging operation. In some implementations, focus component (175) may utilize a focus tracking module (not shown) that is configured to detect a displacement of objective lens assembly (142) relative to a portion of flow cell (110) and output data indicative of an in-focus position to focus component (175) to move objective lens assembly (142) to position the corresponding portion of flow cell (110) in focus of objective lens assembly (142).

In some implementations, an actuator of the focus component (175) or for the sample stage (170) may be physically coupled to objective lens assembly (142), the optical stage, the sample stage (170), or a combination thereof, such as, for example, by mechanical, magnetic, fluidic, or other attachment or contact directly or indirectly to or with the stage or a component thereof. The actuator of the focus component (175) may be configured to move the objective lens assembly (142) in the z-direction while maintaining the sample stage (170) in the same plane (e.g., maintaining a level or horizontal attitude, perpendicular to the optical axis). In some implementations, the sample stage (170) includes an X direction actuator and a Y direction actuator to form an X-Y stage. The sample stage (170) may also be configured to include one or more tip or tilt actuators to tip or tilt sample stage (170) and/or a portion thereof, such as a flow cell chuck. This may be done, for example, so that flow cell (110) may be leveled dynamically to account for any slope in its surfaces.

Camera system (140) may include one or more image sensors to monitor and track the imaging (e.g., sequencing) of flow cell (110). Camera system (140) may be implemented, for example, as a CCD or CMOS image sensor camera, but other image sensor technologies (e.g., active pixel sensor) may be used. By way of further example only, camera system (140) may include a dual-sensor time delay integration (TDI) camera, a single-sensor camera, a camera with one or more two-dimensional image sensors, and/or other kinds of camera technologies. While camera system (140) and associated optical components are shown as being positioned above flow cell (110) in FIG. 1, one or more image sensors or other camera components may be incorporated into system (100) in numerous other ways as will be apparent to those skilled in the art in view of the teachings herein. For instance, one or more image sensors may be positioned under flow cell (110), such as within sample stage (170) or below sample stage (170); or may even be integrated into flow cell (110).

### II. Examples of Imaging Arrangements With Curved Image Plane or Curved Object Plane

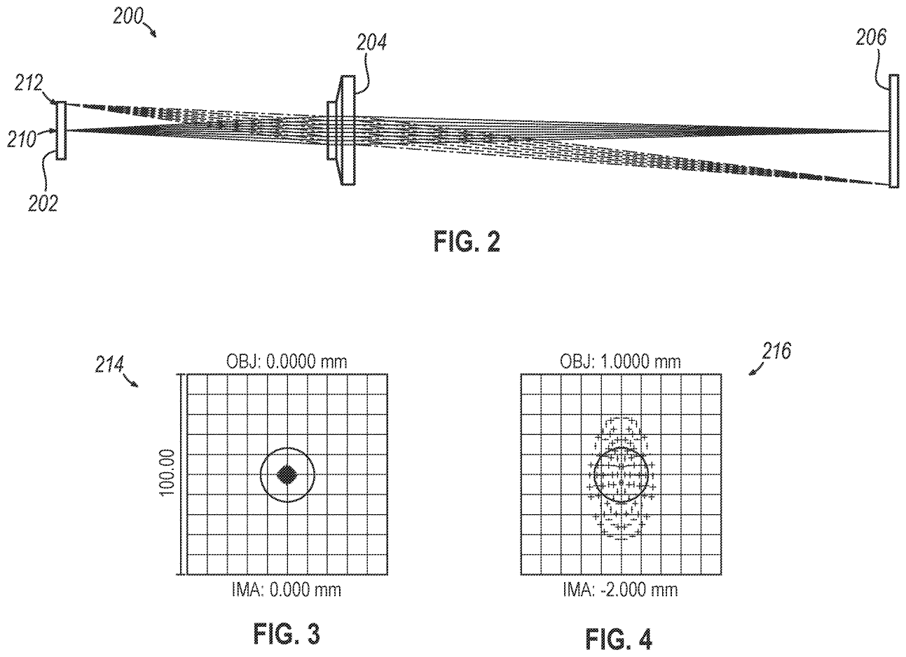

Some versions of system (100) may provide substantially flat reaction sites within flow cell (110); and a substantially flat image sensor in camera system (140). FIG. 2 depicts an example of such an arrangement (200), where an object plane (202) represents a reaction site or collection of reaction sites in a flow cell (110), objective lens (204) represents objective lens assembly (142), and image plane (206) represents an image sensor in camera system (140). Other components of imaging assembly (120) are omitted from FIG. 2 for clarity, it being understood that such components may be provided in accordance with the teachings above and in FIG. 1. In the context of a sequencing process referenced in several examples herein, fluorophores at object plane (202) may emit light in response to excitation light from imaging assembly (120); and objective lens (204) may project the light emitted from those fluorophores onto image plane (206).

FIG. 3 shows an example of a first spot diagram (214) representing an image captured using arrangement (200) of FIG. 2, for the region (210) of the object at the center of the field of view (on axis, 0 mm off-axis). FIG. 4 shows an example of a second spot diagram (216) representing an image captured using arrangement (200) of FIG. 2, for the region (212) of the object at the edge of the field of view (e.g., 1 mm off-axis). Having rays from a given point converge to a pattern in an image plane that is smaller than the diffraction limit may be desirable for high-contrast imaging of small objects packed densely together. As can be seen from spot diagrams (214, 216), rays from the center region (210) of the field of view (OBJ: 0.0000 mm) converge to a pattern that is smaller than the diffraction-limit (shown in spot diagram (214)); while rays from the edge region (212) of the field of view (OBJ: 1.0000 mm) converge to a pattern that is larger than the diffraction limit (shown in spot diagram (216)). In this case, best focus for the center region (210) and the edge region (212) of the field of view are different due to the aberration known as field curvature. Some optical designs may include elements that are included to correct for field curvature.

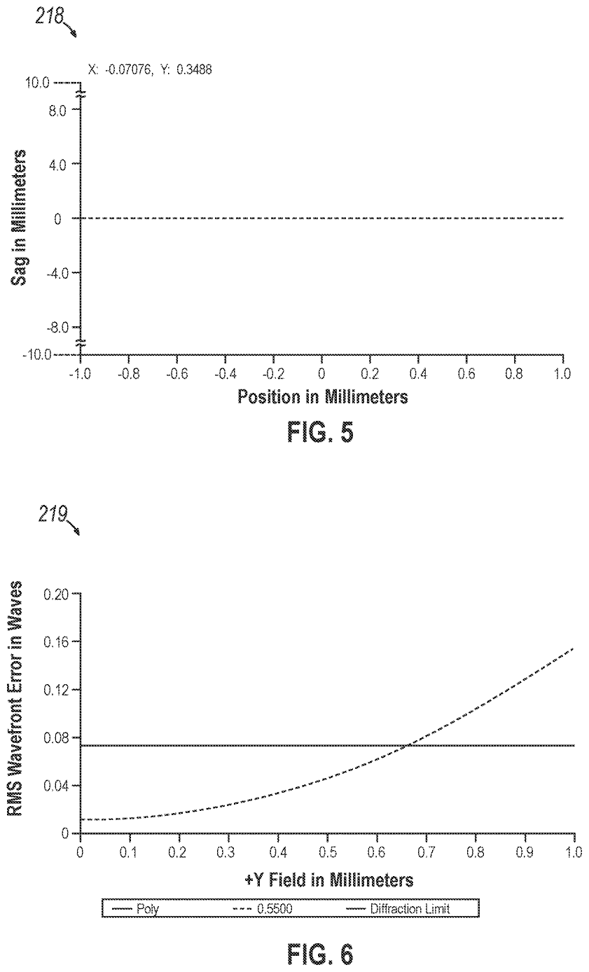

FIG. 5 shows a graph (218) plotting the optical sagitta or sag of the image plane relative to the optical axis of arrangement (200). As can be seen, the sag is uniform across the field of view, indicating the image plane (206) is flat. FIG. 6 shows a graph (219) plotting RMS wavefront error as a function of the field of view of an image captured using arrangement (200). As can be seen from graph (219), the RMS wavefront error increases as the field of view increases. In other words, the optical performance through arrangement (200) degrades as the field of view increases. This performance is diffraction-limited on-axis; but does not remain diffraction-limited over the entire field of view. In the example shown in graph (219), imaging performance is diffraction limited for 0<=Y<=~0.65 mm.

As the Lagrange Invariant for a sequencing system like system (100) increases, the number of lens elements within objective lens assembly (142), and the focus precision required to image analytes with high fidelity, may tend to increase. The increase in lens elements may tend to result in an objective lens assembly (142) with increased volume, mass, complexity, and cost. In some versions of system (100), an actuating assembly (not shown) is used to move at least a portion of imaging assembly (120) relative to flow cell (110) (e.g., along an x-y horizontal plane), to provide imaging of different regions of flow cell (110). In such versions, increases in the mass of objective lens assembly (142) may increase the mechanical demand on the actuating assembly, which may adversely affect the ability of the actuating assembly to precisely position imaging assembly (120) in a rapid fashion. Thus, increasing the mass of objective lens assembly (142) may tend to reduce throughput of system (100) due to the time to move objective lens assembly (142) and/or due to a subsequent dwell time to permit vibrations resulting from the movement to decrease below a threshold value. Additionally, each element in a lens reflects and absorbs a fraction of incident light. As element counts increase, substantial transmission losses may occur that reduce signal recorded by the camera. Some fraction of the energy that is not transmitted is absorbed, heating the absorbing lens element. As lens elements absorb heat, the images can be degraded.

To avoid or minimize such potentially adverse impacts on performance in system (100), it may be beneficial to provide a curvature in either the object plane (i.e., in the imaged object) or the image plane (i.e., in the imaging sensor). Providing such curvature may allow reduction in the size and number of lens elements in the objective lens assembly (120), thereby reducing the mass of objective lens assembly (120) and minimizing the impact on the speed with which a precision motion system may precisely position the objective lens assembly (120). In other words, providing such curvature may provide an increase in the Lagrange Invariant without providing a corresponding increase on the number of lens elements or mass of objective lens assembly (142). Moreover, because the resolution of reaction sites near the edge of the field of view may be improved, a higher throughput may be achievable for the optical system when compared to a system implementing a no curvature in the object plane and/or the image plane. The following describes examples of how such curvature may be provided. While the following provides examples in the context of a system (100) that may be used in nucleotide sequencing processes, the following teachings may also be readily applied in other contexts, including in systems that perform other processes (i.e., other than nucleotide sequencing procedures). The following teachings are thus not necessarily limited to systems that are used to perform nucleotide sequencing processes.

### A. Example of Imaging Arrangement With Curved Image Plane

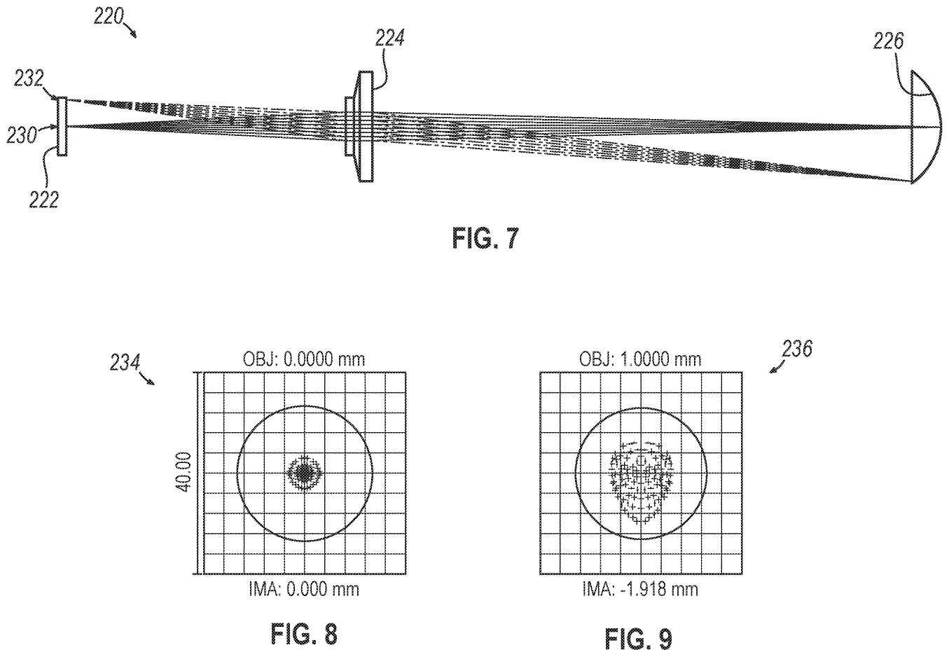

FIG. 7 depicts an example of an arrangement (220) where an object plane (222) represents a reaction site or set of reaction sites in a flow cell (110), objective lens (224) represents objective lens assembly (142), and image plane (226) represents an image sensor in camera system (140). As can be seen in FIG. 7, image plane (226) is curved in this example; while object plane (222) is flat. Other components of imaging assembly (120) are omitted from FIG. 7 for clarity, it being understood that such components may be provided in accordance with the teachings above and in FIG. 1. In the context of a sequencing process referenced in several examples herein, fluorophores at image plane (222) may emit light in response to excitation light from imaging assembly (120); and objective lens (224) may project the light emitted from those fluorophores onto image plane (226).

FIG. 8 shows an example of a first spot diagram (234) representing an image captured using arrangement (220) of FIG. 7, for the region (230) of the object at the center of the field of view (on axis, 0 mm off-axis). FIG. 9 shows an example of a second spot diagram (236) representing an image captured using arrangement (220) of FIG. 7, for the region (232) of the object at the edge of the field of view (e.g., 1 mm off-axis). Having rays from a given point converge to a pattern in an image plane that is smaller than the diffraction limit may be desirable for high-contrast imaging of small objects packed densely together. As can be seen from spot diagrams (234, 236), rays from the center region (210) of the field of view (OBJ: 0.0000 mm) and rays from the edge region (212) of the field of view (OBJ: 1.0000 mm) converge to patterns that are smaller than the diffraction-limit.

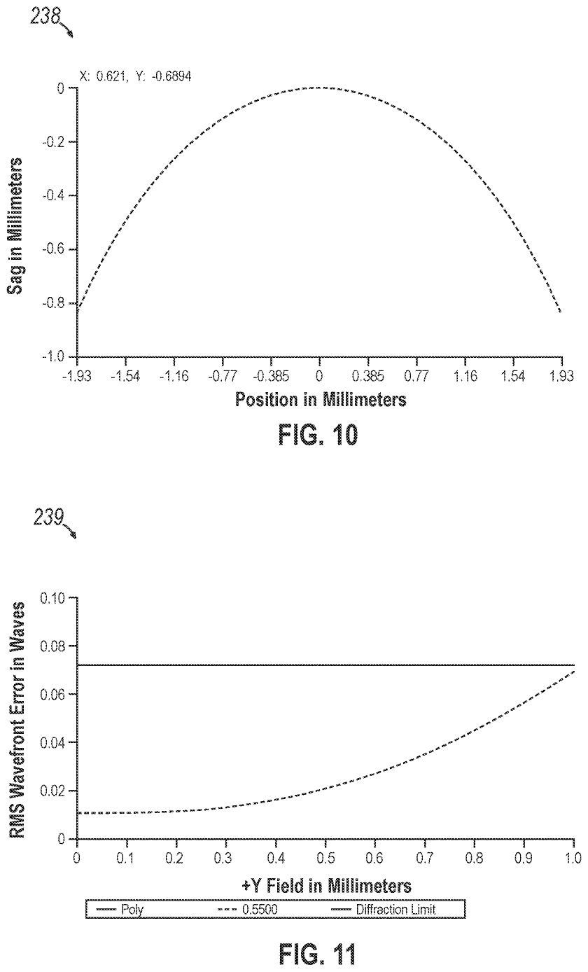

FIG. 10 shows a graph (238) plotting the optical sagitta or sag of the image plane relative to the optical axis of arrangement (220). As can be seen, the sag changes across the field of view is due to the curvature of image plane (226). The sag depicted in graph (238) is just one example, it being understood that other sag values may be realized. FIG. 11 shows a graph (239) plotting RMS wavefront error across a width of an image captured using arrangement (220). As can be seen from graph (239), the RMS wavefront error increases as the field of view increases but is improved as compared to the RMS wavefront error shown in graph (239). In other words, the optical performance through arrangement (220) degrades as the field of view increases. Because the image sensor is curved to compensate for the field-dependence of the best-focus distance (field curvature), the performance, though somewhat degraded with increasing field, remains diffraction-limited over the entire field of view (e.g., through 1.0 mm).
1. Examples of Different Curvature Types

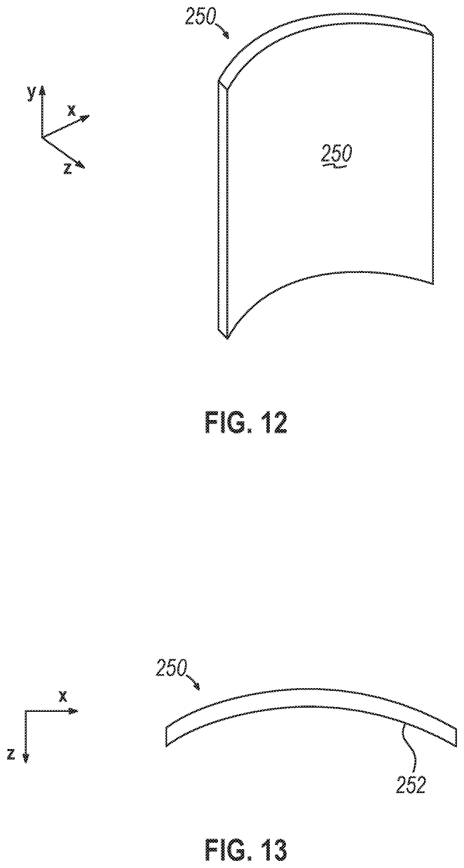

As indicated above, an image sensor may be curved to provide a curved image plane (226). An image sensor may be curved in various different ways in order to achieve a curved image plane. For instance, FIG. 12 shows an example of an image sensor (250) having an imaging surface (252) providing a cylindrically curved image plane. In this example, imaging surface (252) is curved along an x-z plane; but is straight along a y-axis, such that imaging surface (252) defines a portion of a cylinder surface. By way of example only, the radius of curvature of imaging surface (252) along the x-z plane may range from approximately 20 mm to approximately planar (infinity). Alternatively, any other suitable radius of curvature may be used. It should be understood that the curvature of imaging surface (252) is concave in this example, but that convex curvatures may instead be used as appropriate. It should also be understood that the x and z dimensions shown in FIGS. 12-13 are not necessarily the same as the x and z dimensions shown in FIG. 1.

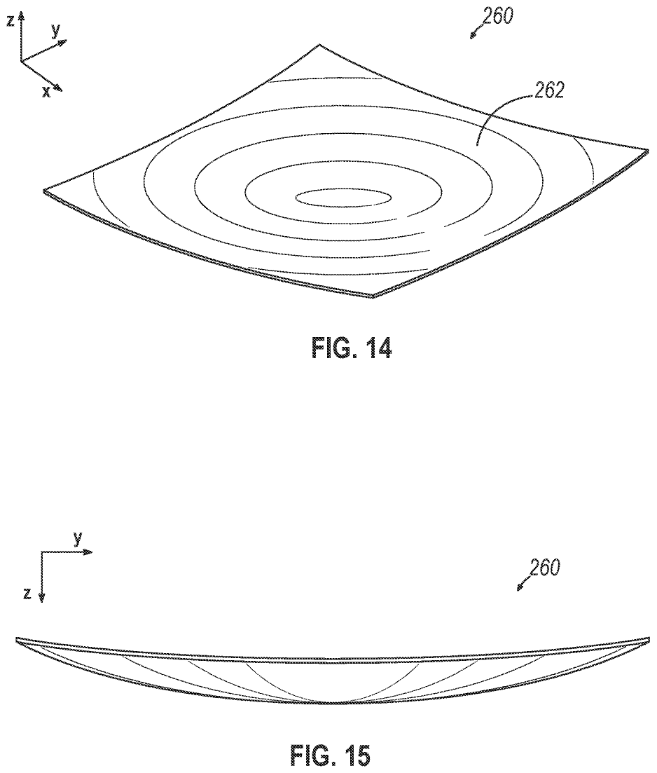

FIGS. 14-15 show an example of an image sensor (260) having an imaging surface (262) providing a spherically curved image plane. In this example, imaging surface (262) is curved along all three axes x, y, and z, such that imaging surface (262) defines a portion of a spherical surface. By way of example only, the radius of curvature of imaging surface (262) may range from approximately 25 mm to approximately planar (infinity). Alternatively, any other suitable radius of curvature may be used. It should be understood that the curvature of imaging surface (262) is concave in this example. It should also be understood that the x and z dimensions shown in FIGS. 14-15 are not necessarily the same as the x and z dimensions shown in FIG. 1.

While FIGS. 12-15 show cylindrical and spherical curvatures for imaging surfaces (252, 262), any other suitable kind of deformation may be used for an imaging surface to define an image plane (226) having any suitable kind of deformation. For instance, some variations may provide an image plane (226) having a freeform profile, where the plane has little to no symmetry. Some freeform profiles may provide a varying radius of curvature, though freeform profiles may come in other forms. Likewise, some profiles may have a varying radius but not constitute a freeform profile, such as where a varying radius profile has substantial symmetry.
2. Examples of Controlled Curvature Arrangements

In some versions, it may be desirable to fixedly secure the shape of imaging surface (252, 262), such that the curve of image plane (226) remains constant throughout use of system (100). For instance, the curve of imaging surface (252, 262) may be permanently rigid by the time image sensor (250, 260) is installed in imaging assembly (120). In some scenarios, image sensor (250, 260) may be configured such that the curve of imaging surface (252, 262) may be selectively varied, such that the curve of image plane may be selected and established on an ad hoc basis. In some such scenarios, the curve of imaging surface (252, 262) may be chosen during a manufacturing process. For instance, camera system (140) may be tested for performance characteristics (e.g., as part of a calibration routine), and the curve of imaging surface (252, 262) may be chosen and varied based on the performance characteristics of camera system (140) at hand. In some such scenarios, even though the curve of imaging surface (252, 262) is varied during the manufacturing process, curve may nevertheless be fixed by the time image sensor (250, 260) is installed in imaging assembly (120) and used in system (100).

In some other scenarios, imaging assembly (120) may be configured such that the curve of imaging surface (252, 262) may be varied after image sensor (250, 260) has been installed in imaging assembly (120); and even after imaging assembly (120) has been installed in system (100). In some such scenarios, the curve of imaging surface (252, 262) may be varied as part of a setup or calibration process. Subsequently, the curve of imaging surface (252, 262) may remain fixed as system (100) is used to perform a sequencing process (or other process). In versions where the curve of imaging surface (252, 262) is varied as part of a setup process, a variety of factors may be employed to determine the appropriate curve for imaging surface (252, 262). Such factors may include, but need not be limited to, performance characteristics of camera system (140), the kind of process in which image sensor (250, 260) will be used, and/or other factors.

Regardless of whether the curve of imaging surface (252, 262) is varied as part of a setup or calibration process, the curve of imaging surface (252, 262) may also be varied as system (100) is used to perform a sequencing process (or other process). For example, a feedback loop may be employed to vary the curve of imaging surface (252, 262) in the middle of a sequencing process (or other process). In versions where the curve of imaging surface (252, 262) is varied during performance of a sequencing process (or other process), a variety of factors may be employed to determine the appropriate curve for imaging surface (252, 262). Such factors may include, but need not be limited to, ray tracing, optical design programs, focus tracking algorithms, signal-to-noise ratio, image contrast, and/or other factors.

The following provides various examples of features that may be used to controllably vary the curve of an image sensor (250, 260), to thereby controllably vary the curve of imaging surface (252, 262), to thereby match the curve of image plane (226) of a given imaging assembly (120). The following examples may be employed in any of the use scenarios referenced above; or in any other suitable scenarios.

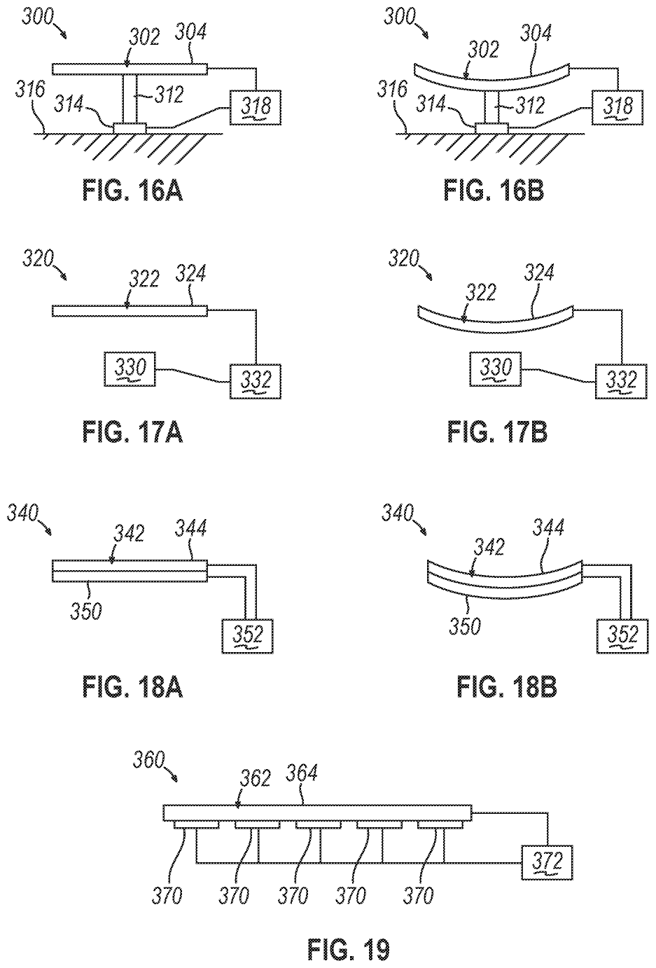

FIGS. 16A-16B show an example of an image sensor assembly (300) that includes an image sensor (302) coupled with a driver (312), which is in turn coupled with an actuator (314). Driver (312) is secured to the underside of image sensor (302), opposite to the imaging surface (304) of image sensor (302). Driver (312) of the present example is in the form of an arm, though it should be understood that driver (312) may take any other suitable form, including but not limited to a jointed or multi-jointed linkage assembly. Actuator (314) is fixedly secured relative to a grounding structure (316). By way of example only, grounding structure (316) may include a chassis, frame, or other rigid element of imaging assembly (120). Actuator (314) may also take any suitable form, including but not limited to a voice coil, a solenoid, etc.

Actuator (314) is further coupled with a control module (318), which is operable to generate signals that electrically power actuator (314) to thereby drive movement of driver (312). In some versions, control module (318) includes or forms at least a portion of controller (195) of system (100). Alternatively, control module (318) may be separate from controller (195). For instance, control module (318) may be directly integrated into imaging assembly (120). Control module (318) may include a processor, a data storage device, and/or any other suitable components operable to perform the functions described herein. In the example shown in FIGS. 16A-16B, control module (318) is also in communication with image sensor (302). In some such versions, control module (318) is configured to process image data captured by image sensor (302). Moreover, control module (318) may be configured to drive actuator (314) based at least in part on image data captured by image sensor (302), as described herein. By way of example only, in some versions, control module (318) tracks the point spread function (PSF) and/or focus of images captured by image sensor (302) and adjusts deformation of image sensor (302) via actuator (314) based at least in part on the PSF and/or focus data. Such a feedback loop may be executed to minimize the PSF and/or otherwise optimize the focus across the field of view.

Image sensor (302) of the present example is deformable, such that image sensor (302) may achieve a bent state without breaking or otherwise preventing image sensor (302) from capturing images. Thus, as shown in the transition from the state shown in FIG. 16A to the state shown in FIG. 16B, actuator (314) may drive driver (312) toward grounding structure (316), thereby bending image sensor (302). As shown in FIG. 16B, this causes image sensor (302) to bend toward grounding structure (316), such that imaging surface (304) is in a concave curved state. In some versions, this curved state of imaging surface (304) provides a cylindrical curve, similar to image sensor (250) of FIGS. 12-13. In some other versions, this curved state of imaging surface (304) provides a spherical curve, similar to image sensor (260) of FIGS. 14-15. Alternatively, any other suitable kind of curve, including convex, may be achieved.

The kind of curve achieved by image sensor (302) may be influenced, at least in part, based on how the perimeter of image sensor (302) is secured relative to grounding structure (316). For instance, to achieve a cylindrical curve, two opposing edges of image sensor (302) may be secured relative to grounding structure (316) while two other opposing edges may move freely relative to grounding structure (316). To achieve a spherical curve, the entire perimeter of image sensor (302) may be secured relative to grounding structure (316). In versions where one or more portions of the perimeter of image sensor are rigidly secured relative to grounding structure (316), image sensor (302) may have some degree of extensibility to accommodate the flexing shown in FIG. 16B. In versions where image sensor (302) is not extensible, one or more portions the perimeter of image sensor (302) may be secured to one or more components that allow those portions of the perimeter of image sensor (302) to move along a plane that is parallel to grounding structure (316) without allowing those portions of the perimeter of image sensor (302) to move toward or away from grounding structure (316). Alternatively, any other suitable arrangements may be used to secure the perimeter of image sensor (302) relative to grounding structure (316).

While only one driver (312) and corresponding actuator (314) are shown in FIGS. 16A-16B, some other versions of image sensor assembly (300) may include more than one driver (312) and corresponding actuator (314). For instance, in versions where image sensor (302) is bent to achieve a cylindrical curve, two or more drivers (312) and corresponding actuators (314) may be positioned along an axis corresponding to the z direction in FIG. 12. Alternatively, a plurality of drivers (312) and corresponding actuators (314) may be positioned in any other suitable arrangement.

In some versions, image sensor (302) is plastically deformable, such that image sensor (302) will maintain the bent state of FIG. 16B after actuator (314) and driver (312) bend image sensor (302). In some such versions, image sensor (302) will not return to the substantially flat state shown in FIG. 16A after reaching the curved state shown in FIG. 16B. In some other versions, image sensor (302) is elastically deformable, such that image sensor (302) will return to the substantially flat state shown in FIG. 16A after reaching the curved state shown in FIG. 16B. For instance, actuator (314) and driver (312) may cooperate to return image sensor (302) to the substantially flat state shown in FIG. 16A. Alternatively, image sensor (302) may be resiliently biased toward the substantially flat state shown in FIG. 16A, such that image sensor (302) may resiliently return to the substantially flat state shown in FIG. 16A when driver (312) releases a deforming force on image sensor (302). While only one single bent state is shown in FIG. 16B, image sensor (302) may achieve various other bent states, such as those providing a larger or smaller radius of curvature (R), than what is shown in FIG. 16B. Moreover, image sensor (302) may be selectively transitioned among various different bent states to vary the bend in image sensor (302) at different times.

FIGS. 17A-17B show an example of an image sensor assembly (320) that includes an image sensor (322) and a contact-free actuator (330). Actuator (330) is positioned underneath image sensor (322), opposite to the imaging surface (324) of image sensor (322), without contacting image sensor (322). While not shown in FIGS. 17A-17B. actuator (330) may be secured to a grounding structure like grounding structure (316). Actuator (330) is operable to pull a corresponding region of image sensor (322) toward actuator (330), to thereby bend image sensor (322). By way of example only, actuator (330) may include an electromagnet, a vacuum source, and/or any other kind(s) of component(s) operable to impose a bending force on image sensor (322) without contacting image sensor (322). In some variations, actuator (330) is positioned above image sensor (322) yet offset enough from the optical axis to not substantially interfere with imaging through image sensor (322). In some such variations, actuator (330) pneumatically drives deformation of image sensor (322).

Actuator (330) is further coupled with a control module (332), which is operable to generate signals that electrically power actuator (330) to thereby drive bending of image sensor (322). In some versions, control module (332) includes or forms at least a portion of controller (195) of system (100). Alternatively, control module (332) may be separate from controller (195). For instance, control module (332) may be directly integrated into imaging assembly (120). Control module (332) may include a processor, a data storage device, and/or any other suitable components operable to perform the functions described herein. In the example shown in FIGS. 17A-17B, control module (332) is also in communication with image sensor (322). In some such versions, control module (332) is configured to process image data captured by image sensor (322). Moreover, control module (332) may be configured to drive actuator (330) based at least in part on image data captured by image sensor (332), as described herein. By way of example only, in some versions, control module (332) tracks the point spread function (PSF) and/or focus of images of images captured by image sensor (324) and adjusts deformation of image sensor (324) via actuator (330) based at least in part on the PSF and/or focus data. Such a feedback loop may be executed to minimize the PSF and/or otherwise optimize the focus across the field of view.

Image sensor (322) of the present example is deformable, such that image sensor (322) may achieve a bent state without breaking or otherwise preventing image sensor (322) from capturing images. Thus, as shown in the transition from the state shown in FIG. 17A to the state shown in FIG. 17B, actuator (330) impart a pulling force on image sensor (322), thereby bending image sensor (322), without contacting image sensor (322), and without damaging image sensor (322). As shown in FIG. 17B, this causes image sensor (322) to achieve a concave curved state. In some versions, this curved state of imaging surface (324) provides a cylindrical curve, similar to image sensor (250) of FIGS. 12-13. In some other versions, this curved state of imaging surface (324) provides a spherical curve, similar to image sensor (260) of FIGS. 14-15. Alternatively, any other suitable kind of curve, including convex, may be achieved.

The kind of curve achieved by image sensor (322) may be influenced, at least in part, based on how the perimeter of image sensor (322) is secured relative to actuator (330). For instance, to achieve a cylindrical curve, two opposing edges of image sensor (332) may be secured relative to actuator (330) while two other opposing edges may move freely relative to actuator (330). To achieve a spherical curve, the entire perimeter of image sensor (322) may be secured relative to actuator (330). In versions where one or more portions of the perimeter of image sensor are rigidly secured relative to actuator (330), image sensor (322) may have some degree of extensibility to accommodate the flexing shown in FIG. 17B. In versions where image sensor (322) is not extensible, one or more portions the perimeter of image sensor (322) may be secured to one or more components that allow those portions of the perimeter of image sensor (322) to move along a plane that is parallel to actuator (330) without allowing those portions of the perimeter of image sensor (322) to move toward or away from actuator (330). Alternatively, any other suitable arrangements may be used to secure the perimeter of image sensor (322) relative to actuator (330).

While only one actuator (330) is shown in FIGS. 17A-17B, some other versions of image sensor assembly (320) may include more than one actuator (330). For instance, in versions where image sensor (322) is bent to achieve a cylindrical curve, two or more actuators (330) may be positioned along an axis corresponding to the z direction in FIG. 12. Alternatively, a plurality of actuators (330) may be positioned in any other suitable arrangement.

In some versions, image sensor (322) is plastically deformable, such that image sensor (322) will maintain the bent state of FIG. 17B after actuator (330) bends image sensor (322). In some such versions, image sensor (322) will not return to the substantially flat state shown in FIG. 17A after reaching the curved state shown in FIG. 17B. In some other versions, image sensor (322) is elastically deformable, such that image sensor (322) will return to the substantially flat state shown in FIG. 17A after reaching the curved state shown in FIG. 17B. For instance, image sensor (322) may be resiliently biased toward the substantially flat state shown in FIG. 17A, such that image sensor (322) may resiliently return to the substantially flat state shown in FIG. 17A when actuator (330) releases a deforming force on image sensor (322). While only one single bent state is shown in FIG. 17B, image sensor (322) may achieve various other bent states, such as those providing a larger or smaller radius of curvature (R), than what is shown in FIG. 17B. Moreover, image sensor (322) may be selectively transitioned among various different bent states to vary the bend in image sensor (322) at different times.

FIGS. 18A-18B show an example of an image sensor assembly (340) that includes an image sensor (342) and an apposed actuator (350). Actuator (350) is positioned underneath image sensor (342), opposite to the imaging surface (344) of image sensor (342), in apposition with the underside of image sensor (342). In the present example, actuator (350) is fixedly secured directly to the underside of image sensor (342), across all or a substantial portion of the surface area of the underside of image sensor (342), such that image sensor (342) and actuator (350) together form a laminate. In some versions, one or more other layers may be interposed between image sensor (342) and actuator (350) as part of this laminate. Also in some versions, some spaces are defined across the interface between actuator (350) and image sensor (342) to further accommodate bending of actuator (350) and image sensor (342) at slightly different respective radii of curvature.

Actuator (350) is operable to controllably deform and thereby bend image sensor (342). By way of example only, actuator (350) may include an electroactive polymer, a magnetorheological/magnetoactivated elastomer, piezoelectric elements, thermally sensitive elements that deform in response to changes in temperature, optically sensitive materials that deform in response to light at certain wavelengths (e.g., within the ultraviolet spectrum), and/or any other kind(s) of component(s) operable to impose a bending force on image sensor (342) while in apposition with image sensor (342) as part of a laminate. In some versions, image sensor (342) and/or actuator (350) includes a liquid crystal elastomer.

Actuator (350) is further coupled with a control module (352), which is operable to generate signals that electrically power actuator (350) to thereby drive bending of image sensor (342). In some versions, control module (352) includes or forms at least a portion of controller (195) of system (100). Alternatively, control module (352) may be separate from controller (195). For instance, control module (352) may be directly integrated into imaging assembly (120). Control module (352) may include a processor, a data storage device, and/or any other suitable components operable to perform the functions described herein. In the example shown in FIGS. 18A-18B, control module (352) is also in communication with image sensor (352). In some such versions, control module (352) is configured to process image data captured by image sensor (342). Moreover, control module (352) may be configured to drive actuator (350) based at least in part on image data captured by image sensor (342), as described herein. By way of example only, in some versions, control module (352) tracks the point spread function (PSF) and/or focus of images captured by image sensor (342) and adjusts deformation of image sensor (342) via actuator (350) based at least in part on the PSF and/or focus data. Such a feedback loop may be executed to minimize the PSF and/or otherwise optimize the focus across the field of view.

Image sensor (342) of the present example is deformable, such that image sensor (342) may achieve a bent state without breaking or otherwise preventing image sensor (352) from capturing images. Thus, as shown in the transition from the state shown in FIG. 18A to the state shown in FIG. 18B, actuator (350) impart a pulling force on image sensor (342), thereby bending image sensor (342), without damaging image sensor (322). As shown in FIG. 18B, this causes image sensor (342) to achieve a concave curved state. In some versions, this curved state of imaging surface (344) provides a cylindrical curve, similar to image sensor (250) of FIGS. 12-13. In some other versions, this curved state of imaging surface (344) provides a spherical curve, similar to image sensor (260) of FIGS. 14-15. Alternatively, any other suitable kind of curve, including convex, may be achieved.

The kind of curve achieved by image sensor (342) may be influenced, at least in part, based on the form of construction of actuator (350) and/or the arrangement in which actuator (350) is secured to the underside of image sensor (342). Image sensor (342) and/or actuator (350) may have some degree of extensibility to accommodate the flexing shown in FIG. 18B. While only one actuator (350) is shown in FIGS. 18A-18B, some other versions of image sensor assembly (340) may include more than one actuator (350), in any suitable arrangement.

In some versions, image sensor (342) is plastically deformable, such that image sensor (342) will maintain the bent state of FIG. 18B after actuator (350) bends image sensor (342). In some such versions, image sensor (342) will not return to the substantially flat state shown in FIG. 18A after reaching the curved state shown in FIG. 18B. In some other versions, image sensor (342) is elastically deformable, such that image sensor (342) will return to the substantially flat state shown in FIG. 18A after reaching the curved state shown in FIG. 18B. For instance, image sensor (342) may be resiliently biased toward the substantially flat state shown in FIG. 18A, such that image sensor (342) may resiliently return to the substantially flat state shown in FIG. 18A when actuator (350) releases a deforming force on image sensor (342). While only one single bent state is shown in FIG. 18B, image sensor (342) may achieve various other bent states, such as those providing a larger or smaller radius of curvature (R), than what is shown in FIG. 18B. Moreover, image sensor (342) may be selectively transitioned among various different bent states to vary the bend in image sensor (342) at different times.
3. Examples of Bend Sensing Elements

In some scenarios where an image sensor (250, 260, 302, 322, 342) is driven to bend (e.g., via an actuator (314, 330, 350) or otherwise), it may be desirable to provide one or more sensors that are operable to generate signals indicating the degree of bending in image sensor (250, 260, 302, 322, 342). Such data may be beneficial to determine the radius of curvature (R) in real time. By way of example only, the real-time radius of curvature (R) data may be used as part of a feedback loop as part of the control for actuator (314, 330, 350), such that actuator (314, 330, 350) may be activated until the desired radius of curvature (R) has been achieved (as detected by one or more bend sensing elements). In addition, or in the alternative, data from one or more bend sensing elements may provide real-time data indicating the degree of mechanical stress being imparted to an image sensor (250, 260, 302, 322, 342), such that the mechanical stress data may be used to prevent image sensor (250, 260, 302, 322, 342) from being bent to a point where image sensor (250, 260, 302, 322, 342) will be damaged. As another example, data from one or more bend sensing elements may be used to measure stress over time to correct for drift to maintain optimum focus of the optical system; and/or to measure the change in radius of curvature in response to changes in temperature. Data from one or more bend sensing elements may also be used to keep image sensor (250, 260, 302, 322, 342) above a minimum bend radius. Data from one or more bend sensing elements may also be used to identify and reject image sensors (250, 260, 302, 322, 342) that have an excessive intrinsic field curvature. For instance, an automated routine may be used to find the optimal sensor curvature. That routine may be executed; and the resulting bend sensing element data evaluated. If the automatically set and then measured curvature (1/radius) goes above a certain level, the image sensor (250, 260, 302, 322, 342) may be identified as having excessive field curvature and may thereby be rejected for further use. Alternatively, data from one or more bend sensing elements may be used for any other purpose(s).

FIG. 19 shows an example of an image sensor assembly (360) that includes an image sensor (362) and a plurality of bend sensing elements (370). Bend sensing elements (370) are positioned underneath image sensor (362), opposite to the imaging surface (364) of image sensor (362), in apposition with the underside of image sensor (362). In the present example, each bend sensing element (370) is fixedly secured directly to the underside of image sensor (362), with bend sensing elements (370) being spaced apart from each other across the underside of image sensor (362). In some versions, one or more other layers may be interposed between image sensor (362) and each bend sensing element (370).

While not shown in FIG. 19, image sensor assembly (360) may further include one or more actuators that is/are operable to drive bending of image sensor (362). For instance, such an actuator may be configured and operable like any of the actuators (314, 330, 350) described herein. Bend sensing elements (370) are configured to generate signals indicating the degree of bending of image sensor (362). By way of example only, bend sensing elements (370) may include strain gauges, photoelasticity sensors, polarimeters, polariscopes, acoustic emission sensors, x-ray diffraction sensors, spherometers, total indicator runout gauges, dial indicators, and/or any other suitable component(s) operable to generate signals indicating the degree of bending of image sensor (362).

Bend sensing elements (370) are further coupled with a control module (372), which is operable to receive and process signals generated by bend sensing elements (370). In the present example, control module (372) is also coupled with image sensor (362), such that control module (372) is also operable to receive and process signals generated by image sensor (362). In addition, or in the alternative, control module (372) may be coupled with an actuator (e.g., any of the actuators (314, 330, 350) described herein), such that control module (372) may be operable to generate signals that electrically power the actuator to thereby drive bending of image sensor (362). By way of further example only, control module (372) may be configured to drive the actuator based at least in part on image data captured by image sensor (364) and/or based at least in part on data from bend sensing elements (370). In some versions, control module (372) includes or forms at least a portion of controller (195) of system (100). Alternatively, control module (372) may be separate from controller (195). For instance, control module (372) may be directly integrated into imaging assembly (120). Control module (372) may include a processor, a data storage device, and/or any other suitable components operable to perform the functions described herein.

While several examples described above include variations where the entire image sensor (250, 260, 302, 322, 342, 362) is curved to provide a curved image plane (226), some versions of an image sensor may be configured to provide a curved image plane (226) without the entire image sensor being curved. For instance, some image sensors may comprise a three-dimensional stack of silicon die. In such versions, the region of the stack where the photons are converted to electrons may be curved; while regions of the stack that are not directly in the optical path need not necessarily be curved. Such regions of the stack that are not directly in the optical path may be flat.

The foregoing teachings may be readily applied to various kinds of camera systems (140). For instance, the foregoing teachings may be applied to camera systems (140) that include a dual-sensor time delay integration (TDI) camera, a single-sensor camera, a camera with one or more two-dimensional image sensors, and/or other kinds of camera systems (140). In other words, image sensor (250, 260, 302, 322, 342, 362) may be in the form of a TDI image sensor or any other suitable kind of image sensor. In addition, while examples provided above include imaging surfaces (252, 262, 304, 324, 344, 364) providing symmetric forms of curves, such curves need not necessarily be symmetric in all versions. Some variations may provide an imaging surface (252, 262, 304, 324, 344, 364) having a freeform profile, where the plane has little to no symmetry. Some freeform profiles may provide a varying radius of curvature, though freeform profiles may come in other forms. Likewise, some profiles may have a varying radius but not constitute a freeform profile, such as where a varying radius profile has substantial symmetry.

B. Example of Imaging Arrangement with Curved Object Plane

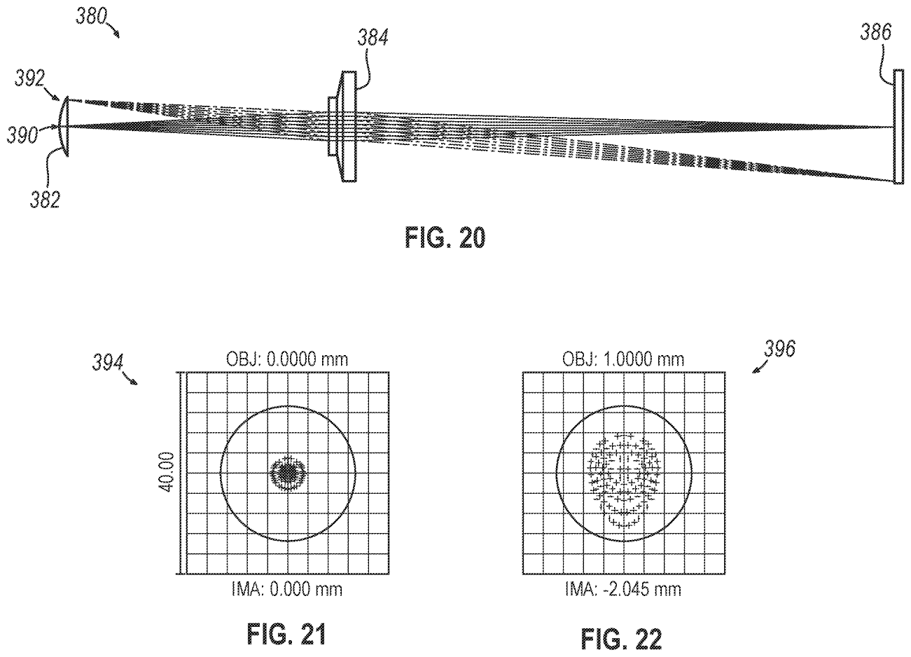

In addition to, or in lieu of, providing a bend in an image plane (206, 226) as described above in the context of FIGS. 7-19, it may be desirable to provide a bend in an object plane (202, 222). To that end, FIG. 20 depicts an example of an arrangement (380) where an object plane (382) represents at least one reaction site in a flow cell (110), objective lens (384) represents objective lens assembly (142), and image plane (386) represents an image sensor in camera system (140). As can be seen in FIG. 20, object plane (382) is curved in this example; while image plane (386) is flat. Other components of imaging assembly (120) are omitted from FIG. 20 for clarity, it being understood that such components may be provided in accordance with the teachings above and in FIG. 1. In the context of a sequencing process referenced in several examples herein, fluorophores at image plane (382) may emit light in response to excitation light from imaging assembly (120); and objective lens (384) may project the light emitted from those fluorophores onto image plane (386).

FIG. 21 shows an example of a first spot diagram (394) representing an image captured using arrangement (380) of FIG. 20, for the region (390) of the object at the center of the field of view (on axis, 0 mm off-axis). FIG. 22 shows an example of a second spot diagram (396) representing an image captured using arrangement (380) of FIG. 20, for the region (392) of the object at the edge of the field of view (e.g., 1 mm off-axis). Having rays from a given point converge to a pattern in an image plane that is smaller than the diffraction limit may be desirable for high-contrast imaging of small objects packed densely together. As can be seen from spot diagrams (394, 396), rays from the center region (390) of the field of view (OBJ: 0.0000 mm) and rays from the edge region (392) of the field of view (OBJ: 1.0000 mm) converge to patterns that are smaller than the diffraction-limit.

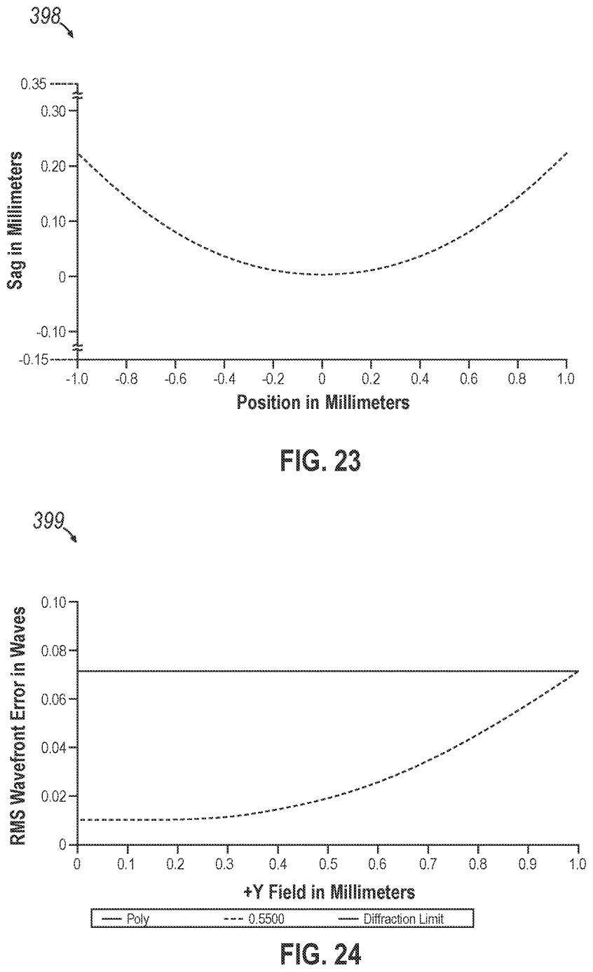

FIG. 23 shows a graph (398) plotting the optical sagitta or sag of the object plane relative to the optical axis of arrangement (380). As can be seen, the sag changes across the field of view, due to the curvature of object plane (382). The sag depicted in graph (398) is just one example, it being understood that other sag values may be realized. FIG. 24 shows a graph (399) plotting RMS wavefront error across a width of an image captured using arrangement (380). As can be seen from graph (399), the RMS wavefront error increases as the field of view increases. In other words, the optical performance through arrangement (380) degrades as the field of view increases. Because the object is curved to compensate for the field-dependence of the best-focus distance (field curvature), the performance, though somewhat degraded with increasing field, remains diffraction-limited over the entire field of view.

In comparing arrangement (220) of FIG. 7 with arrangement (380) of FIG. 20, it should be understood that the sag associated with curved object plane (382) may be substantially less than the sag associated with curved image plane (226) when the magnification through objective lens (224, 384) is greater than 1. This is due to the fact that the sag value is proportional to the square of the magnification. The appropriate sag for either the object or the image surface is determined by the lens properties. A given lens will have a surface (e.g., a non-flat surface) that has the best image quality over a given field of view. This shape of this surface may be predicted by optical modeling software or measured. In the present example, the sag of the object or image surface may be set so that the object or image surface are coincident with or nearly coincident with the surface that has the best image quality.

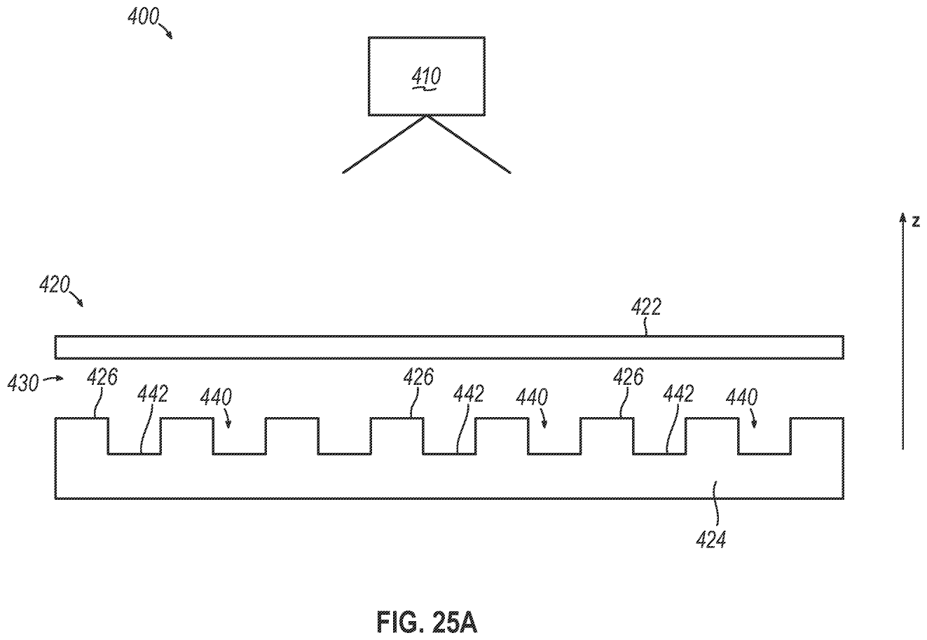

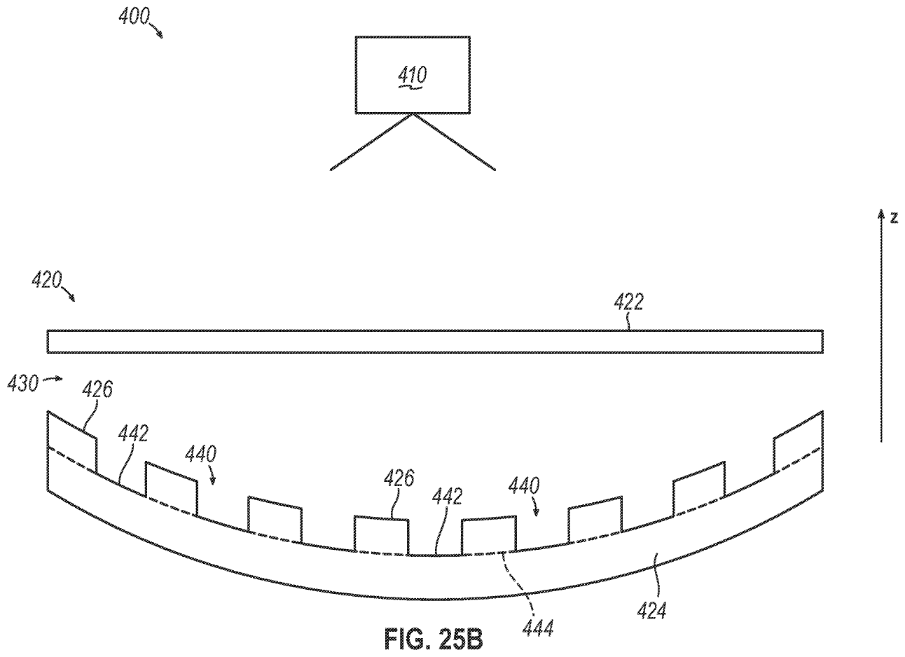

FIGS. 25A-25B schematically depict an arrangement (400) that includes a flow cell (420) and an imaging assembly (410). Except as otherwise described below, flow cell (420) may be configured and operable like flow cell (110) described above; while imaging assembly (410) may be configured and operable like imaging assembly (120) described above. Flow cell (420) of this example includes a cover plate (422) and a substrate (424), with a flow channel (430) defined between cover plate (422) and substrate (424). While not shown in FIGS. 25A-25B, one or more additional layers of material may be interposed between cover plate (422) and substrate (424). In some implementations, a second substrate (not shown) may also be formed on an interior surface of the cover plate (422) and arranged opposite the substrate (424).

Substrate includes an upper surface (426) and defines a plurality of wells (440), with each well (440) having a respective floor (442) that is recessed relative to upper surface (426). Flow cell (420) is configured such that a solution from system (100) flows through flow channel (430) and reaches wells (440), with reactions occurring in wells (440). In particular, each floor (442) provides a discrete reaction site in the present example. By way of example only, each floor (442) may include a cluster (e.g., a monoclonal cluster, a substantially monoclonal cluster, or a polyclonal cluster) of a biological sample such as DNA, RNA, or another genomic material that may be sequenced, for example, using sequencing by synthesis. A substantially monoclonal cluster may be one where a particular sample forms a distinguishable portion of the cluster even if the cluster itself is polyclonal as a result of one or more other samples being present within the cluster. In some other variations, wells (440) are omitted. In some such versions, the reaction sites are provided directly on upper surface (426) (e.g., in the form of a microarray across upper surface (426)). In some other versions, the reaction sites are provided on pillars or other structures that extend upwardly from upper surface (426). Thus, while the examples described below provide reaction sites in the context of floors (442) of wells (440), the same teachings below may be readily applied to arrangements where the reaction sites are provided on other structural features of a flow cell.

Imaging assembly (410) emits light to illuminate the reaction sites provided at floors (442). Cover plate (422) includes an optically transmissive material (e.g., glass, etc.), such that the light emitted from imaging assembly (410) passes through cover plate (422) to reach the reaction sites at floors (442). In versions where one or more layers are interposed between cover plate (422) and substrate (424), such layers may provide sufficient optical transmissivity to enable the light emitted from imaging assembly (410) to reach the reaction sites at floors (442). The material within wells (440), and particularly at floors (442), may include fluorophores that emit light in response to the excitation light from imaging assembly (410). This light emitted by the fluorophores may pass back through cover plate (422) and be picked up by one or more image sensors within imaging assembly (410). This light that is picked up by one or more image sensors within imaging assembly (410) may indicate the types of nucleotides within wells (440) and/or other properties of the substances within wells (440). Thus, in the present example, referring back to the context of arrangements (200, 220, 380), the reaction sites at floors (442) together provide a collective object plane (202, 222, 382).

Flow cell (420) of the present example is further configured such that substrate (424) may transition from a substantially flat state (as shown in FIG. 25A) to a bent state (as shown in FIG. 25B). By way of example only, an actuator (not shown) may be operable to drive bending of substrate (424) in the z-direction. Such an actuator may be configured and operable like any of the actuators (314, 330, 350) described above; or may have any other suitable configuration and method of operation. Thus, the details of each of the above-described actuators (314, 330, 350) will not be repeated here, it being understood that the above teachings relating to actuators (314, 330, 350) may be readily applied to substrate (424) as if substrate (424) were considered as a substitute for image sensors (302, 324, 342) in the descriptions provided with reference to FIGS. 16A-18B.

While not shown in FIGS. 25A-25B, the one or more actuators that drive bending of substrate (424) may be further coupled with a control module. Like control modules (318, 332, 352) described above, a control module that is coupled with the one or more actuators that drive bending of substrate (424) may generate signals that electrically power the one or more actuators. Similarly, a control module that is coupled with the one or more actuators that drive bending of substrate (424) may also be coupled with an image sensor in imaging assembly (410). In some variations, flow cell (420) may also include one or more bend sensing elements (e.g., similar to bend sensing elements (370)) that are operable to sense bending of substrate (424). Thus, the same teachings above provided in the context of driving and tracking bending of image sensors (302, 324, 342, 362) may also be applied to substrate (424).

As shown in FIG. 25B, with substrate (424) in a bent state, floors (442) are all positioned along a curved plane (444). In other words, the reaction sites of flow cell (420) are all positioned along curved plane (444). In the bent state, curved plane (444) may provide a cylindrical curve, similar to image sensor (250) of FIGS. 12-13. In some other versions, curved plane (444) provides a spherical curve, similar to image sensor (260) of FIGS. 14-15. Alternatively, any other suitable kind of curve may be achieved. In some versions, substrate (424) is plastically deformable, such that substrate (424) will maintain the bent state of FIG. 25B after the actuator bends substrate (424). In some such versions, substrate (424) will not return to the substantially flat state shown in FIG. 25A after reaching the curved state shown in FIG. 25B. In some other versions, substrate (424) is elastically deformable, such that substrate (424) will return to the substantially flat state shown in FIG. 25A after reaching the curved state shown in FIG. 25B. For instance, substrate (424) may be resiliently biased toward the substantially flat state shown in FIG. 25A. While only one single bent state is shown in FIG. 25B, substrate (424) may achieve various other bent states, such as those providing a larger or smaller radius of curvature (R), than what is shown in FIG. 25B.

In some variations of flow cell (420), the curvature of substrate (424) is fixed at the time of manufacture, such that the curvature is not dynamically adjustable as described above. Thus, flow cell (420) or each channel or portions of each channel may remain configured as depicted in FIG. 25B upon completion of manufacture and throughout use. By way of example only, a flow cell (420) may be manufactured with a fixedly curved substrate (424) using nanoimprint lithography. Such a version of substrate (424) may include glass, silicon, and/or any other suitable material(s). As another illustrative example, a manufacturing process for flow cell (420) may include hot embossing of nanopatterned laminates onto a precurved surface. As yet another illustrative example, a manufacturing process for flow cell (420) may include nanoimprint lithography on a flat substrate (424), with subsequent stress engineering. Such stress engineering may include deposition of additional layers with well-controlled residual stress on at least one of the substrates (top and bottom) to achieve required curvature of substrate (424) after wafer bonding and dicing. As yet another illustrative example, flow cell (420) may be formed by bonding two types of glass substrates with different thermal expansion coefficients. The mismatch in coefficient of thermal expansion between different top and bottom glass wafers upon temperature variation (e.g., heating), may generate a thermal residual stress of the bonded wafer stack, which may manifest as curvature of the bonded wafer stack and consequently also curvature of substrate (424). In some implementations, the curvature of substrate (424) may be formed in the plane substantially perpendicular to the longitudinal length of the flow cell (420). For instance, the curvature of the substrate (424) may be formed for the flow cell (420) as a whole, for each of one or more channels of the flow cell (420), and/or for a portion of each of the once or more channels, such as a swath, of the flow cell (420). Alternatively, any other suitable manufacturing techniques may be used.

While the foregoing example of flow cell (420) provides bending of substrate (424) but not cover plate (422), some other versions may provide bending of cover plate (422). For instance, cover plate (422) may bend with substrate (424) in some variations. In addition, while the foregoing example of flow cell (420) provides bending of the entirety of substrate (424), some other versions may provide bending of only a portion of substrate (424). For instance, only a portion of substrate (424) that effectively positions reaction sites of floors (442) along curved plane (444) may bend in some variations. While the underside of substrate (424) is shown as being curved in FIG. 25B, in some variations the underside of substrate (424) may be flat while reaction sites of floors (442) are positioned along curved plane (444).

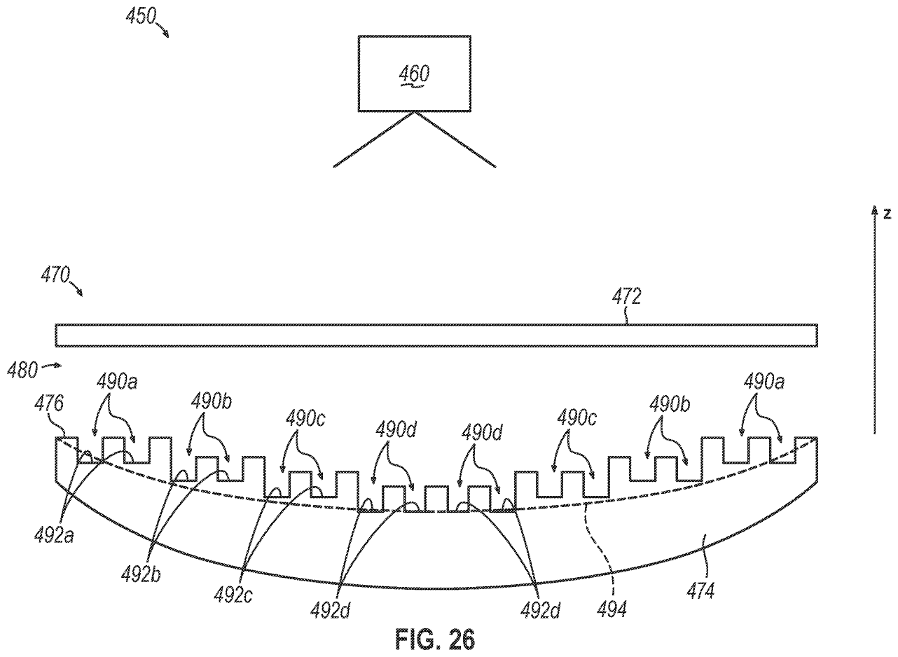

FIG. 26 shows an alternative arrangement (450) that includes a flow cell (470) and an imaging assembly (460). Except as otherwise described below, flow cell (470) may be configured and operable like flow cell (110) described above; while imaging assembly (460) may be configured and operable like imaging assembly (120) described above. Flow cell (470) of this example includes a cover plate (472) and a substrate (474), with a flow channel (480) defined between cover plate (472) and substrate (474). While not shown in FIG. 26, one or more additional layers of material may be interposed between cover plate (472) and substrate (474). In some implementations, a second substrate (not shown) may also be formed on an interior surface of the cover plate (422) and arranged opposite the substrate (424).

Substrate (474) includes an upper surface (476) and defines a plurality of wells (490), with each well (490) having a respective floor (492) that is recessed relative to upper surface (476). Flow cell (470) is configured such that a solution from system (100) flows through flow channel (480) and reaches wells (490), with reactions occurring in wells (490). In particular, each floor (492) provides a discrete reaction site in the present example. By way of example only, each floor (492) may include a cluster (e.g., a monoclonal cluster, a substantially monoclonal cluster, or a polyclonal cluster) of a biological sample such as DNA, RNA, or another genomic material that may be sequenced, for example, using sequencing by synthesis. A substantially monoclonal cluster may be one where a particular sample forms a distinguishable portion of the cluster even if the cluster itself is polyclonal as a result of one or more other samples being present within the cluster. In some other variations, wells (490) are omitted. In some such versions, the reaction sites are provided directly on upper surface (476) (e.g., in the form of a microarray across upper surface (476)). In some other versions, the reaction sites are provided on pillars or other structures that extend upwardly from upper surface (476). Thus, while the examples described below provide reaction sites in the context of floors (492) of wells (490), the same teachings below may be readily applied to arrangements where the reaction sites are provided on other structural features of a flow cell.

Imaging assembly (460) emits light to illuminate the reaction sites provided at floors (492). Cover plate (472) includes an optically transmissive material (e.g., glass, etc.), such that the light emitted from imaging assembly (460) passes through cover plate (472) to reach the reaction sites at floors (492). In versions where one or more layers are interposed between cover plate (472) and substrate (474), such layers may provide sufficient optical transmissivity to enable the light emitted from imaging assembly (460) to reach the reaction sites at floors (492). The material within wells (490), and particularly at floors (492), may include fluorophores that emit light in response to the excitation light from imaging assembly (460). This light emitted by the fluorophores may pass back through cover plate (472) and be picked up by one or more image sensors within imaging assembly (460). This light that is picked up by one or more image sensors within imaging assembly (460) may indicate the types of nucleotides within wells (490) and/or other properties of the substances within wells (490). Thus, in the present example, referring back to the context of arrangements (200, 220, 380), the reaction sites at floors (492) together provide a collective object plane (202, 222, 382).

In the present example, substrate (474) is configured such that wells (490) and their corresponding floors (492) are provided in tiers, such that a first set of wells (490a) and corresponding floors (492a) are provided at a first tier, a second set of wells (490b) and corresponding floors (492b) are provided at a second tier, a third set of wells (490c) and corresponding floors (492c) are provided at a third tier, and a fourth set of wells (490d) and corresponding floors (492d) are provided at a fourth tier. The number of tiers, and the number of wells (490) and corresponding floors (492) at each tier, may be varied from this example. Despite the tiered arrangement of wells (490) and corresponding floors (492), the reaction sites at floors (492) are still generally positioned along a curved plane (494), such that floors (492) lie on iso-contours. Curved plane (494) may provide a cylindrical curve, similar to image sensor (250) of FIGS. 12-13; a spherical curve, similar to image sensor (260) of FIGS. 14-15; or any other suitable kind of curve.

In some versions, substrate (474) is constructed such that the reaction sites at floors (492) are generally positioned along a curved plane (494) in a fixed manner, such that floors (492) do not transition from being along a single flat plane to being generally positioned along curved plane (494). In some other versions, at least a portion of substrate (474) is deformable or otherwise operable to reposition floors (494) along the z-direction. Such versions may employ the use of one or more actuators in accordance with the teachings above. In some implementations, the curved plane (494) of substrate (474) may be formed in the plane substantially perpendicular to the longitudinal length of the flow cell (470). For instance, the curvature of the substrate (474) may be formed for the flow cell (470) as a whole, for each of one or more channels of the flow cell (470), and/or for a portion of each of the once or more channels, such as a swath, of the flow cell (470).

The foregoing teachings may be readily applied in the context of various kinds of camera systems in imaging assembly (410, 460). For instance, the foregoing teachings may be applied in the context of an imaging assembly (410, 460) that includes a dual-sensor time delay integration (TDI) camera, a single-sensor camera, a camera with one or more two-dimensional image sensors, and/or other kinds of camera systems (140). In addition, while examples provided above include curved planes (444, 494) providing symmetric forms of curves, such curves need not necessarily be symmetric in all versions. Some variations of curved planes (444, 494) may have a freeform profile.

### C. Example of Imaging Arrangement With Virtually Curved Image Plane or Object Plane

In some scenarios, rather than necessarily curving an image sensor (250, 260, 302, 322, 342) or the structure defining floor (434), similar results may be achieved by positioning a curved optical element directly adjacent to an image sensor or in substantially close proximity to reaction sites of a flow cell. In other words, positioning a curved optical element directly adjacent to an image sensor may effectively provide a curved image plane. Similarly, positioning a curved optical element in substantially close proximity to reaction sites of a flow cell may effectively provide a curved object plane.

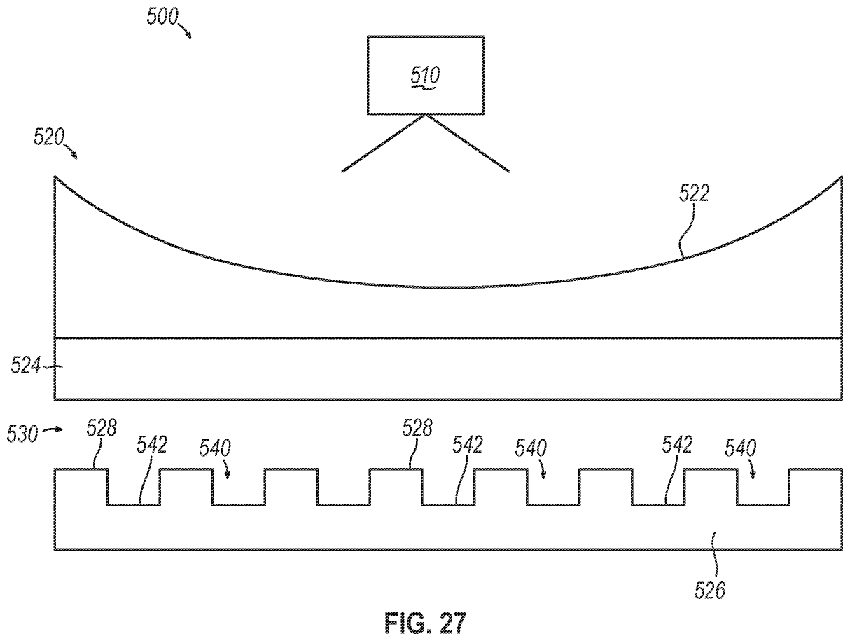

FIG. 27 depicts another example of an arrangement (500) that includes a flow cell (520) and an imaging assembly (510). Except as otherwise described below, flow cell (500) may be configured and operable like flow cell (110) described above; while imaging assembly (510) may be configured and operable like imaging assembly (120) described above. Flow cell (520) of this example includes a lens element (522), a cover plate (524), and a substrate (526). While not shown in FIG. 27, one or more additional layers of material may be interposed between cover plate (524) and substrate (526). Similarly, one or more additional layers of material may be interposed between lens element (522) and cover plate (524). In the present example, lens element (522) is in direct apposition with cover plate (524).

Substrate (528) includes an upper surface (528) and defines a plurality of wells (540), with each well (540) having a respective floor (542) that is recessed relative to upper surface (528). Flow cell (520) is configured such that a solution from system (100) flows through flow channel (530) and reaches wells (540), with reactions occurring in wells (540). In particular, each floor (542) provides a discrete reaction site in the present example. By way of example only, each floor (542) may include a cluster (e.g., a monoclonal cluster, a substantially monoclonal cluster, or a polyclonal cluster) of a biological sample such as DNA, RNA, or another genomic material that may be sequenced, for example, using sequencing by synthesis. A substantially monoclonal cluster may be one where a particular sample forms a distinguishable portion of the cluster even if the cluster itself is polyclonal as a result of one or more other samples being present within the cluster. In some other variations, wells (540) are omitted. In some such versions, the reaction sites are provided directly on upper surface (528) (e.g., in the form of a microarray across upper surface (528)). In some other versions, the reaction sites are provided on pillars or other structures that extend upwardly from upper surface (528). Thus, while the examples described below provide reaction sites in the context of floors (542) of wells (540), the same teachings below may be readily applied to arrangements where the reaction sites are provided on other structural features of a flow cell.

Imaging assembly (510) emits light to illuminate the reaction sites provided at floors (542). The light emitted from imaging assembly (460) passes through lens element (522). Lens element (522) of the present example is concave and spans across the width of the region of flow cell (520) where wells (540) are defined. Thus, light emitted from imaging assembly (510) that ultimately reaches the reaction sites passes through lens element (522). Similarly, light emitted from the reaction sites passes through lens element (522) en route to imaging assembly (510). While lens element (522) is concave in the present example, other versions of lens element (522) may include a gradient index lens, an aspheric lens, or a Fresnel lens. Alternatively, lens element (522) may have any other suitable configuration.

Cover plate (524) includes an optically transmissive material (e.g., glass, etc.), such that the light emitted from imaging assembly (510) and passing through lens element (522) also passes through cover plate (524) to reach the reaction sites at floors (542). In versions where one or more layers are interposed between cover plate (524) and substrate (526), such layers may provide sufficient optical transmissivity to enable the light emitted from imaging assembly (510) to reach the reaction sites at floors (542). The material within wells (540), and particularly at floors (542), may include fluorophores that emit light in response to the excitation light from imaging assembly (510). This light emitted by the fluorophores may pass back through cover plate (522) and lens element (522) and be picked up by one or more image sensors within imaging assembly (510). This light that is picked up by one or more image sensors within imaging assembly (510) may indicate the types of nucleotides within wells (542) and/or other properties of the substances within wells (542). Thus, in the present example, referring back to the context of arrangements (200, 220, 380), the reaction sites at floors (542) together provide a collective object plane (202, 222, 382). Due to the substantially close proximity of lens element (522) to the reaction sites at floors (542), and due to the structural configuration and optical characteristics of lens element (522), lens element (522) may provide an optical effect that is substantially equivalent to the reaction sites being positioned along a curved plane (e.g., like curved planes (444, 494)).

In some variations of arrangement (500), the image sensor is positioned under substrate (526), or at least under floors (542), instead of being positioned within imaging assembly (510). In some such versions, imaging assembly (510) may still emit excitation light as described above. Also in such versions, substrate (526) may include an optically transmissive material to allow light emitted from fluorophores at the reaction sites in response to the excitation light to reach the image sensor. Moreover, instead of being positioned atop flow cell (520), lens element (522) may be positioned under floors (542), such that the light emitted from fluorophores at the reaction sites in response to the excitation light passes through lens element (522) en route to the image sensor.

While one single lens element (522) is sized and position to effectively cover all wells (540), some variations of flow cell (520) may provide separate lens elements (522) for one or more wells (540). For instance, some variations may provide a lens element (522) per well (540) and a well (540) per lens element (522), such that there is a 1:1 relationship between the number of lens elements (522) and the number of wells (540). As another example, some variations of flow cell (520) may provide a plurality of lens elements (522) but have several wells (540) associated with each lens element (522), such that each lens element (522) has an associated group of wells (540).

The foregoing teachings may be readily applied in the context of various kinds of camera systems in imaging assembly (510). For instance, the foregoing teachings may be applied in the context of an imaging assembly (510) that includes a dual-sensor time delay integration (TDI) camera, a single-sensor camera, a camera with one or more two-dimensional image sensors, and/or other kinds of camera systems (140).

### III. Examples of Combinations

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

An apparatus, comprising: a flow cell comprising a plurality of reaction sites, the flow cell being configured to receive a fluid and an excitation light, each reaction site being configured to contain a biological sample carried by the fluid, the reaction sites together being positioned along a reaction site plane; and an image sensor positioned to receive light emitted from the reaction site in response to the excitation light, the image sensor defining an imaging surface, the imaging surface defining an imaging surface plane; one or both of the reaction site plane or the imaging surface plane being curved.

### Example 2

The apparatus of Example 1, one or both of the reaction site plane or the imaging surface plane including a cylindrically curved plane.

### Example 3

The apparatus of Example 1, one or both of the reaction site plane or the imaging surface plane including a spherically curved plane.

### Example 4

The apparatus of any of Examples 1 through 3, one or both of the reaction site plane or the imaging surface plane having a freeform profile.

### Example 5

The apparatus of any of Example 1 through 4, at least a portion of the flow cell or the image sensor being flexible to permit adjustment of the reaction site plane or the imaging surface plane.

### Example 6

The apparatus of any of Examples 1 through 5, further comprising an actuator, the actuator being operable to controllably bend at least a portion of the flow cell or the image sensor to thereby controllably change the curve of the reaction site plane or the imaging surface plane.

### Example 7

The apparatus of Example 6, further comprising a driver coupling the actuator with the at least a portion of the flow cell or the image sensor.

### Example 8

The apparatus of Example 6, the actuator being operable to drive bending of the at least a portion of the flow cell or the imaging surface without contact between the actuator and the at least a portion of the flow cell or the image sensor.

### Example 9

The apparatus of Example 8, the actuator including an electromagnet.

### Example 10

The apparatus of Example 8, the actuator including a vacuum source.

### Example 11

The apparatus of Example 8, the actuator comprising a positive pneumatic pressure source.

### Example 12

The apparatus of Example 6, the actuator being positioned in apposition with the at least a portion of the flow cell or the image sensor, such that the actuator forms a laminate with the at least a portion of the flow cell or the image sensor.

### Example 13

The apparatus of Example 12, the actuator comprising an electroactive polymer.

### Example 14

The apparatus of Example 12, the actuator comprising a magnetoactivatead elastomer

### Example 15

The apparatus of Example 12, the actuator comprising one or more piezoelectric elements.

### Example 16

The apparatus of Example 12, the actuator comprising one or more thermally sensitive elements configured to deform in response to a change in temperature.

### Example 17

The apparatus of Example 12, the actuator comprising one or more optically sensitive elements configured to deform in response to light.

### Example 18

The apparatus of Example 17, the one or more optically sensitive elements being configured to deform in response to light in the ultraviolet spectrum.

### Example 19

The apparatus of any of any of Examples 6 through 18, further comprising a processor, the processor being configured to: receive signals from the image sensor, determine a focus value of an image captured by the image sensor, and drive the actuator in response to the determined focus value.

### Example 20

The apparatus of any of any of Examples 6 through 18, further comprising a processor, the processor being configured to: receive signals from the image sensor, determine a point spread function (PSF) of an image captured by the image sensor, and drive the actuator in response to the determined PSF.

### Example 21

The apparatus of any of Examples 6 through 20, the image sensor including a first side and a second side, the first side of the image sensor including the imaging surface, the actuator being positioned at the second side of the image sensor, opposite to the imaging surface.

### Example 22

The apparatus of Example 21, at least a portion of the image sensor contacting the second side of the image sensor.

### Example 23

The apparatus of any of Examples 1 through 22, further comprising one or more bend sensing elements, the one or more bend sensing elements being configured to sense bending in at least a portion of the flow cell or the image sensor and thereby generate signals indicating one or more curvatures in the reaction site plane or the imaging surface plane.

### Example 24

The apparatus of Example 23, the one or more bend sensing elements including one or more strain gauges.

### Example 25

The apparatus of any of Examples 23 through 24, further comprising a processor, the processor being configured to: receive signals from the one or more bend sensing elements, and determine a bending characteristic of the at least a portion of the flow cell or the image sensor based on at least the received signals from the one or more bend sensing elements.

### Example 26

The apparatus of Example 25, the bending characteristic including a curvature of the reaction site plane or the imaging surface plane.

### Example 27

The apparatus of any of Examples 25 through 26, further comprising an actuator, the actuator being operable to controllably bend at least a portion of the flow cell or the image sensor to thereby controllably change the curve of the reaction site plane or the imaging surface plane; the processor being further configured to drive the actuator based at least in part on signals from the one or more bend sensing elements.

### Example 28

The apparatus of Example 27, the processor being further configured to regulate driving of the actuator, based at least in part on signals from the one or more bend sensing elements, to prevent bending-induced damage to the at least a portion of the flow cell or the image sensor.

### Example 29

The apparatus of any of Examples 25 through 28, the processor being further configured to receive signals from the image sensor.

### Example 30

The apparatus of any of Examples 1 through 4, the curve of the reaction site plane or the imaging surface plane being rigidly defined by the flow cell or the image sensor.

### Example 31

The apparatus of any of Examples 1 through 30, the flow cell being configured to perform sequencing by synthesis at the reaction sites.

### Example 32

The apparatus of any of Examples 1 through 31, further comprising a light source configured to generate the excitation light, the image sensor and the light source together forming part of an imaging assembly, the flow cell being removably positionable relative to the imaging assembly.

### Example 33

An apparatus, comprising: a flow cell comprising a plurality of reaction sites, the flow cell being configured to receive a fluid and an excitation light, each reaction site being configured to contain a biological sample carried by the fluid; and an image sensor positioned to receive light emitted from the reaction site in response to the excitation light, the image sensor including an imaging surface defining a curved plane.

### Example 34

An apparatus, comprising: a flow cell comprising a plurality of reaction sites, the flow cell being configured to receive a fluid and an excitation light, each reaction site being configured to contain a biological sample carried by the fluid, the reaction sites together being positioned along a reaction site plane, the reaction site plane being curved; and an image sensor positioned to receive light emitted from the reaction sites in response to the excitation light.

### Example 35

An apparatus, comprising: a flow cell comprising a plurality of reaction sites, the flow cell being configured to receive a fluid and an excitation light, each reaction site being configured to contain a biological sample carried by the fluid; and an image sensor positioned to receive light emitted from the reaction sites in response to the excitation light; the flow cell further comprising a curved surface associated with the reaction sites, the curved surface being configured to present the reaction sites as being positioned along a curved object plane to the image sensor.

### Example 36

The apparatus of Example 35, the reaction sites being positioned adjacent to the curved surface.

### Example 37

The apparatus of Example 35, the flow cell further comprising at least one integral optical element positioned between the image sensor and at least one corresponding reaction site of the plurality of reaction sites, each integral optical element defining the curved surface associated with the reaction site.

### Example 38

The apparatus of any of Examples 35 through 37, the curved surface providing a concave curvature facing the image sensor.

### Example 39

A method comprising: communicating excitation light toward biological samples on reaction sites in a flow cell, the reaction sites together being positioned along a reaction site plane; and receiving light emitted from the reaction site in response to the excitation light, the emitted light being received via an image sensor, the image sensor having an imaging surface, the imaging surface defining an imaging surface plane; one or both of the reaction site plane or the imaging surface plane being curved.

### Example 40

The method of Example 39, further comprising controllably changing the curve of the plane of the reaction site plane or the imaging surface plane.

### Example 41

The method of Example 40, controllably changing the curved plane comprising activating an actuator.

### Example 42

The method of Example 41, the actuator being coupled with at least a portion of the flow cell or the image sensor via a driver.

### Example 43

The method of Example 42, the actuator including a voice coil, the activated actuator driving the driver via electromagnetic force.

### Example 44

The method of Example 41, the activated actuator controllably changing the curved plane without contact between the actuator and the at least a portion of the flow cell or the image sensor.

### Example 45

The method of Example 44, the activating the actuator including applying a magnetic force via the actuator to cause bending of the at least a portion of the flow cell or the imaging surface.

### Example 46

The method of Example 44, the activating the actuator including applying a vacuum via the actuator to cause bending of the at least a portion of the flow cell or the imaging surface.

### Example 47

The method of Example 44, the activating the actuator including applying positive pneumatic pressure via the actuator to cause bending of the at least a portion of the flow cell or the imaging surface.

### Example 48

The method of Example 41, the actuator being positioned in apposition with the at least a portion of the flow cell or the image sensor, such that the actuator forms a laminate with the at least a portion of the flow cell or the image sensor, the activating the actuator including bending the actuator to thereby bend the at least a portion of the flow cell or the imaging surface.

### Example 49

The method of Example 48, the activating the actuator including applying electrical energy to the actuator.

### Example 50

The method of Example 48, the activating the actuator including applying a magnetic field to the actuator.

### Example 51

The method of Example 48, the activating the actuator including applying thermal energy to the actuator.

### Example 52

The method of Example 48, the activating the actuator including applying light to the actuator.

### Example 53

The method of Example 52, the light including light in the ultraviolet spectrum.

### Example 54

The method of any of Examples 40 through 53, further comprising determining a focus value of an image captured by the image sensor; the controllably changing the curved plane being performed in response to the determined focus value.

### Example 55

The method of any of Examples 40 through 53, further comprising determining a point spread function (PSF) of an image captured by the image sensor; the controllably changing the curved plane being performed in response to the determined PSF.

### Example 56

The method of any of Examples 40 through 55, further comprising fixing the curvature of the curved plane after controllably changing the curved plane.

### Example 57

The method of Example 56, the reaction site plane being curved, the method further comprising seating the flow cell in a sequencing system, the communicating excitation light and receiving light emitted from the reaction site being performed while the flow cell is seated in the sequencing system.

### Example 58

The method of Example 57, the curvature of the reaction site plane being fixed before seating the flow cell in the sequencing system, such that fixing the curvature of the curved plane is performed before the flow cell is seated in the sequencing system.

### Example 59

The method of Example 57, the curvature of the reaction site plane being fixed after seating the flow cell in the sequencing system, such that fixing the curvature of the curved plane is performed while the flow cell is seated in the sequencing system.

### Example 60

The method of Example 56, the imaging surface plane being curved, the image sensor being installed in a sequencing system, the communicating excitation light and receiving light emitted from the reaction site being performed while the image sensor is installed in the sequencing system.

### Example 61

The method of Example 60, the curvature of the imaging surface plane being fixed before seating the image sensor is installed in the sequencing system.

### Example 62

The method of Example 60, the curvature of the imaging surface plane being fixed after the image sensor is installed in the sequencing system, such that fixing the curvature of the curved plane is performed while the image sensor is installed in the sequencing system.

### Example 63

The method of any of Examples 40 through 62, the curved plane being defined by the floor, the method further comprising seating the flow cell in a sequencing system, the communicating excitation light and receiving light emitted from the reaction site being performed while the flow cell is seated in the sequencing system, the controllably changing the curved plane being performed before the flow cell is seated in the sequencing system.

### Example 64

The method of Example 63, further comprising controllably changing the curved plane again after the flow cell is seated in the sequencing system.

### Example 65

The method of any of Examples 40 through 57, the reaction site plane being curved, the method further comprising seating the flow cell in a sequencing system, the communicating excitation light and receiving light emitted from the reaction site being performed while the flow cell is seated in the sequencing system, the controllably changing the curved plane being performed after the flow cell is seated in the sequencing system.

### Example 66

The method of any of Examples 40 through 62, the imaging surface plane being curved, the image sensor being installed in a sequencing system, the communicating excitation light and receiving light emitted from the reaction site being performed while the image sensor is installed in the sequencing system, the controllably changing the curved plane being performed before the image sensor is installed in the sequencing system.

### Example 67

The method of Example 66, further comprising controllably changing the curved plane again while the image sensor is installed in the sequencing system.

### Example 68

The method of any of Examples 40 through 57, the imaging surface plane being curved, the image sensor being installed in a sequencing system, the communicating excitation light and receiving light emitted from the reaction site being performed while the image sensor is installed in the sequencing system, the controllably changing the curved plane being performed after the image sensor is installed in the sequencing system.

### Example 69

The method of any of Examples 40 through 68, the reaction site plane or the imaging surface plane being substantially flat before controllably changing the curved plane, such that controllably changing the curved plane changes the plane from being substantially flat to being curved.

### Example 70

The method of any of Examples 40 through 69, further comprising: receiving a signal from one or more bend sensing elements; and determining a bending characteristic of at least a portion of the flow cell or the image sensor based on at least the received signals from the one or more bend sensing elements.

### Example 71

The method of Example 70, the bending characteristic including a curvature of the curved plane.

### Example 72

The method of any of Examples 70 through 71, further comprising driving an actuator based at least in part on the determined bending characteristic.

### Example 73

The method of Example 72, the driven actuator causing bending of the at least a portion of the flow cell or the imaging surface.

### Example 74

The method of Example 73, further comprising regulating driving of the actuator, based at least in part on the determined bending characteristic, to prevent bending-induced damage to the at least a portion of the flow cell or the image sensor.

### Example 75

The method of any of Examples 39 through 74, further comprising performing a sequencing by synthesis process at the reaction sites.

### Example 76

A method comprising: communicating excitation light toward a biological sample on a floor of a reaction site in a flow cell; and receiving light emitted from the reaction site in response to the excitation light, the emitted light being received via an image sensor, the image sensor having an imaging surface, the image sensor including an imaging surface defining a curved plane.

### Example 77

A method comprising: communicating fluid through a flow cell, the flow cell comprising a plurality of reaction sites, each reaction site containing a biological sample carried by the fluid, the reaction sites together being positioned along a curved plane; communicating excitation light toward the biological samples at the reaction sites; and receiving light emitted from the reaction sites along the curved plane in response to the excitation light, the emitted light being received via an image sensor

### IV. Miscellaneous

It is to be understood that the subject matter described herein is not limited in its application to the details of construction and the arrangement of components set forth in the description herein or illustrated in the drawings hereof. The subject matter described herein is capable of other implementations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

When used in the claims, the term “set” should be understood as one or more things which are grouped together. Similarly, when used in the claims “based on” should be understood as indicating that one thing is determined at least in part by what it is specified as being “based on.” Where one thing is required to be exclusively determined by another thing, then that thing will be referred to as being “exclusively based on” that which it is determined by.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Also, it is to be understood that phraseology and terminology used herein with reference to device or element orientation (such as, for example, terms like “above,” “below,” “front,” “rear,” “distal,” “proximal,” and the like) are only used to simplify description of one or more examples described herein, and do not alone indicate or imply that the device or element referred to must have a particular orientation. In addition, terms such as “outer” and “inner” are used herein for purposes of description and are not intended to indicate or imply relative importance or significance.

It is to be understood that the above description is intended to be illustrative, and not restrictive. For example, the above-described examples (and/or aspects thereof) may be used in combination with each other. In addition, many modifications may be made to adapt a particular situation or material to the teachings of the presently described subject matter without departing from its scope. While the dimensions, types of materials and coatings described herein are intended to define the parameters of the disclosed subject matter, they are by no means limiting and instead illustrations. Many further examples will be apparent to those of skill in the art upon reviewing the above description. The scope of the disclosed subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f) paragraph, unless and until such claim limitations expressly use the phrase “means for” followed by a statement of function void of further structure.

The following claims recite aspects of certain examples of the disclosed subject matter and are considered to be part of the above disclosure. These aspects may be combined with one another.

1. An apparatus, comprising:
a flow cell comprising a plurality of reaction sites, the flow cell being configured to receive a fluid and an excitation light, each reaction site being configured to contain a biological sample carried by the fluid, the reaction sites together being positioned along a reaction site plane; and
an image sensor positioned to receive light emitted from the reaction site in response to the excitation light, the image sensor defining an imaging surface, the imaging surface defining an imaging surface plane;
the imaging surface plane being curved.

2. The apparatus of claim 1, one or both of the reaction site plane or the imaging surface plane including a cylindrically curved plane.

3. The apparatus of claim 1, one or both of the reaction site plane or the imaging surface plane including a spherically curved plane.

4. The apparatus of claim 1, one or both of the reaction site plane or the imaging surface plane having a freeform profile.

5. The apparatus of claim 1, at least a portion of the flow cell or the image sensor being flexible to permit adjustment of the reaction site plane or the imaging surface plane.

6. The apparatus of claim 1, further comprising an actuator, the actuator being operable to controllably bend at least a portion of the image sensor to thereby controllably change the curve of the imaging surface plane.

7. The apparatus of claim 6, further comprising a driver coupling the actuator with the at least a portion of the image sensor.

8. The apparatus of claim 6, the actuator being operable to drive bending of the at least a portion of the imaging surface without contact between the actuator and the at least a portion of the flow cell or the image sensor.

9-18. (canceled)

19. The apparatus of claim 6, further comprising a processor, the processor being configured to:
receive signals from the image sensor,
determine a focus value of an image captured by the image sensor, and
drive the actuator in response to the determined focus value.

20. The apparatus of claim 6, further comprising a processor, the processor being configured to:
receive signals from the image sensor,
determine a point spread function (PSF) of an image captured by the image sensor, and
drive the actuator in response to the determined PSF.

21. The apparatus of claim 6, the image sensor including a first side and a second side, the first side of the image sensor including the imaging surface, the actuator being positioned at the second side of the image sensor, opposite to the imaging surface.

22. (canceled)

23. The apparatus of claim 1, further comprising one or more bend sensing elements, the one or more bend sensing elements being configured to sense bending in at least a portion of the image sensor and thereby generate signals indicating one or more curvatures in the imaging surface plane.

24. The apparatus of claim 23, the one or more bend sensing elements including one or more strain gauges.

25. The apparatus of claim 23, further comprising a processor, the processor being configured to:
receive signals from the one or more bend sensing elements, and
determine a bending characteristic of the at least a portion of the image sensor based on at least the received signals from the one or more bend sensing elements.

26. The apparatus of claim 25, the bending characteristic including a curvature of the imaging surface plane.

27. The apparatus of any of claim 25, further comprising an actuator, the actuator being operable to controllably bend at least a portion of the image sensor to thereby controllably change the curve of the imaging surface plane;
the processor being further configured to drive the actuator based at least in part on signals from the one or more bend sensing elements.

28-29. (canceled)

30. The apparatus of claim 1, the curve of the imaging surface plane being rigidly defined by the image sensor.

31. The apparatus of claim 1, the flow cell being configured to perform sequencing by synthesis at the reaction sites.

32-75. (canceled)

76. A method comprising:
communicating excitation light toward a biological sample on a floor of a reaction site in a flow cell; and
receiving light emitted from the reaction site in response to the excitation light, the emitted light being received via an image sensor, the image sensor having an imaging surface, the image sensor including an imaging surface defining a curved plane.

77. A method comprising:
communicating fluid through a flow cell, the flow cell having a first side and a second side, the flow cell comprising a plurality of reaction sites, each reaction site containing a biological sample carried by the fluid, the reaction sites together being positioned along a curved plane;
communicating excitation light toward the biological samples at the reaction sites, the excitation light being communicated through the first side of the flow cell to reach the biological samples at the reaction sites; and
receiving light emitted from the reaction sites along the curved plane in response to the excitation light, the emitted light being received via an image sensor, the emitted light passing through the first side of the flow cell to be received via the image sensor.
